(19) United States
(12) Patent Application Publication
(10) Pub. No.: US 2023/0196315 A1
(43) Pub. Date: Jun. 22, 2023

(54) EVENT OPTIMIZATION IN A MULTI-TENANT COMPUTING ENVIRONMENT

(71) Applicant: Zuora, Inc., Redwood City, CA (US)

(72) Inventors: Maria Nicoletta Sooklaris, San Francisco, CA (US); Dashiell Stander, Berkeley, CA (US); Alvin Gordon Beyerlein, III, Asheville, NC (US); Daniel Piotr Chudy, Riverside, CT (US); Cameron Robert Lockhart, Atlanta, GA (US)

(21) Appl. No.: 17/554,717

(22) Filed: Dec. 17, 2021

(51) Int. Cl. G06Q 20/10; G06Q 20/14; G06Q 20/38; G06N 20/00

(52) U.S. Cl. CPC G06Q 20/102; G06Q 20/108; G06Q 20/14; G06Q 20/389; G06N 20/00

(57) ABSTRACT

Machine learning-based techniques are described that enable determining an optimal timing schedule for retries of a failed event such as a failed payment transaction. A payment retry optimization machine learning model is trained using ground-truth payment outcome data to obtain a trained model configured to identify an optimal timing schedule for one or more retries of a failed payment transaction based on various inputs including a time of the failed payment transaction, a set of payment attributes, an overall payment retry period, and a maximum number of retries to be attempted.

### TECHNICAL FIELD

This disclosure pertains to multi-tenant computing systems, and more particularly to event optimization, such as failed payment retry optimization, in a multi-tenant computing environment.

### BACKGROUND

In a multi-tenant computing environment, one or more of the tenants may operate according to a subscription-based model, whereby subscribers of a tenant receive one or more services from the tenant on a continuous or periodic basis and are billed for the services on a subscription basis. In a typical subscription billing scenario, an account holder/subscriber is periodically billed according to a schedule established by the tenant and/or customized by the subscriber. The account holder's profile may be associated with one or more forms of payment, and the tenant (or a service provider that manages the multi-tenant computing environment) may initiate a payment attempt against a selected form of payment according to a payment schedule. The payment schedule may be established by the tenant and/or customized by the subscriber. Payment attempts may be triggered automatically or may occur in response to a manual trigger such as when an account holder manually schedules a payment. A payment attempt may include initiating a payment transaction against a payment gateway. A payment transaction may either succeed (i.e., the payment transaction is successfully processed) or fail. If a payment fails, the payment is typically attempted again one or more times. There are a number of technical problems associated with conventional techniques for retrying payments.

### SUMMARY

Machine learning-based failed event retry optimization techniques are disclosed for determining an optimal timing schedule for retries of a failed event such as a failed payment transaction. A payment retry optimization machine learning model may be trained using ground-truth payment outcome data to obtain a trained model configured to identify an optimal timing schedule for one or more retries of a failed payment transaction based on various inputs including a time of the failed payment transaction, a set of payment attributes, an overall payment retry period, and a maximum number of retries to be attempted. The ground-truth payment outcome data may include attribute information for historical payment transactions including payment transactions which were successfully processed as well as payment transactions which failed.

In some embodiments, the trained machine learning model may be configured to determine optimal timing for retrying a failed transaction based on a failure type for the transaction (as determined from a payment response code returned by a payment gateway) and a tenant/subscriber segment corresponding to the account holder with whom the transaction is associated. As noted, the trained machine learning model may determine the optimal payment retry timing within various input constraints such as an overall payment retry window and a maximum number of permissible payment retries. Further, the tenant/subscriber segment selected for determining, at least in part, the optimal timing schedule for retries of a failed payment transaction can be a cross-tenant subscriber group, a single-tenant subscriber group, or an individual subscriber depending on the amount of historical ground-truth payment outcome data available to the machine learning model.

In an example embodiment, a method for event timing optimization in a multi-tenant computing environment is disclosed. The method includes obtaining event outcome data indicating a failure type of each of a plurality of failed events; using the event outcome data as training data to train an event retry optimization machine learning model; using the trained event retry optimization machine learning model to determine a timing schedule for retrying a particular failed event of the plurality of failed events for a particular tenant in the multi-tenant computing environment, the timing schedule being based on event outcome trends observed for a subscriber segment associated with the particular failed event; and retrying the particular failed event in accordance with the determined timing schedule.

In an example embodiment, the plurality of events is a plurality of attempted payment transactions, the particular failed event is a particular attempted payment transaction corresponding to a particular subscriber belonging to the subscriber segment of the particular tenant, and the timing schedule is a payment retry timing schedule.

In an example embodiment, the failure type includes a failure response code indicative of a reason for failure.

In an example embodiment, obtaining the event outcome data includes receiving a first failure response code associated with a first schema, the first failure response code corresponding to a first failed payment transaction of the plurality of attempted payment transactions; receiving a second failure response code associated with a second schema different from the first schema, the second failure response code corresponding to a second failed payment transaction of the plurality of attempted payment transactions; and generating the event outcome data at least in part by normalizing the first failure response code and the second failure response code to a uniform failure code format.

In an example embodiment, normalizing the first failure response code and the second failure response code includes determining that the first failure response code and the second failure response code identify respective reasons for failure that are categorized into a same failure category and mapping the first failure response code and the second failure response code to the uniform failure code format.

In an example embodiment, retrying the failed payment transaction in accordance with the determined payment retry timing schedule includes determining an overall payment retry period for retrying the failed payment transaction one or more times and scheduling a last retry of the failed payment transaction within a last payment retry window immediately preceding an end of the overall payment retry period.

In an example embodiment, retrying the failed payment transaction one or more times in accordance with the determined payment retry timing schedule further includes determining a time that the failed payment transaction initially failed; determining that a maximum number of retries of the failed payment transaction has not been met; determining that a duration of the overall payment retry period accommodates an initial payment retry window that begins after expiration of a first waiting period following the time that the failed payment transaction initially failed such that a time period between an end of the initial payment retry window and a beginning of a first payment retry window subsequent to the initial payment retry window is at least as long as a second waiting period; and scheduling an initial retry of the failed payment transaction within the initial payment retry window.

In an example embodiment, the first waiting period has a longer duration than the second waiting period.

In an example embodiment, retrying the failed payment transaction in accordance with the determined payment retry timing schedule further includes determining that the maximum number of retries of the failed payment transaction has not been met; determining that the duration of the overall payment retry period accommodates an intermediate payment retry window that begins after expiration of the second waiting period following the initial payment retry window such that a time period between an end of the intermediate payment retry window and a beginning of a first payment retry window subsequent to the intermediate payment retry window is at least as long as the second waiting period; and scheduling an intermediate retry of the failed payment transaction within the intermediate payment retry window.

In an example embodiment, retrying the failed payment transaction in accordance with the determined payment retry timing schedule further includes determining that the maximum number of retries of the failed payment transaction has not been met; determining that the duration of the overall payment retry period cannot accommodate an intermediate payment retry window that begins after expiration of the second waiting period following the initial payment retry window because a period of time between an end of the intermediate payment retry window and a beginning of a first payment retry window subsequent to the intermediate payment retry window would be shorter in duration than the second waiting period; and excluding the intermediate payment retry window from the determined payment retry timing schedule.

In an example embodiment, a system for optimizing timing of recurring payment retries of a failed payment transaction includes at least one memory storing computer-executable instructions and at least one processor configured to access the at least one memory and execute the computer-executable instructions to perform a set of operations. The set of operations includes training a payment retry optimization machine learning model using historical payment outcome data as training data, the historical payment outcome data indicating a failure type of each of a plurality of failed payment transactions; applying the trained payment retry optimization machine learning model to a particular failed payment transaction to obtain a set of one or more optimal payment retry times for a subscriber segment to which the particular failed payment transaction relates, the set of one or more optimal payment retry times for the subscriber segment being based on event outcome trends observed for the subscriber segment associated with the particular failed event; and retrying the particular failed payment transaction at the one or more optimal payment retry times.

In an example embodiment, the set of operations further includes obtaining payment outcome data for retries of the particular failed payment transaction at the set of one or more optimal payment retry times and providing the payment outcome data as feedback training data to the trained payment retry optimization machine learning model to enhance the trained payment retry optimization machine learning model to output a new set of one or more optimal payment retry times.

In an example embodiment, the particular failed payment transaction is a first failed payment transaction, and the set of operations further includes applying the enhanced payment retry optimization machine learning model to a second failed payment transaction relating to the subscriber segment to obtain a set of one or more tenant-specific optimal payment retry times that account for the payment outcome trends observed in the subscribers of the specific tenant who belong to the subscriber segment and retrying the second failed payment transaction at the set of one or more tenant-specific optimal payment retry times.

In an example embodiment, the payment outcome data is first payment outcome data, and the set of operations further includes obtaining second payment outcome data for one or more retries of the second failed payment transaction at the set of one or more tenant-specific optimal payment retry times and providing the second payment outcome data as additional feedback training data to the enhanced payment retry optimization machine learning model to further enhance the payment retry optimization machine learning model to output a new set of optimal payment retry times.

In an example embodiment, the set of operations further includes performing a normalization of the historical payment outcome data and providing the normalized historical payment outcome data as training data to the payment retry optimization machine learning model.

In an example embodiment, performing the normalization of the historical payment outcome data includes determining that different payment response codes from different payment gateways are each indicative of a particular type of payment failure; categorizing the different payment response codes into a failed payment category associated with the particular type of payment failure; and mapping the different payment response codes to a uniform failure code formal representative of the particular type of payment failure.

In an example embodiment, training the payment retry optimization machine learning model using the historical payment outcome data as training data includes learning parameters of the payment retry optimization machine learning model through optimization of a function evaluated across each payment attempt represented in the historical payment outcome data.

In an example embodiment, the trained payment retry optimization machine learning model approximates a conditional probability distribution for whether an input payment transaction succeeds based on a timing of the input payment transaction and a set of vector attributes associated with the input payment transaction.

In an example embodiment, the set of operations further includes receiving a maximum number of payment retries and an overall payment retry period as input constraints, where the trained payment retry optimization machine learning model is configured to output the set of optimal payment retry times for the failed payment transaction based on the input constraints.

In an example embodiment, the maximum number of payment retries and the overall payment retry period are user-configurable for the subscriber segment.

In an example embodiment, a computer program product for optimizing timing of recurring payment retries of a failed payment transaction is disclosed. The computer program product includes a non-transitory computer-readable medium readable by a processing circuit. The non-transitory computer-readable medium stores instructions executable by the processing circuit to cause a method to be performed. The method includes training a payment retry optimization machine learning model using historical payment outcome data as training data, the historical payment outcome data indicating a failure type of each of a plurality of failed payment transactions; applying the trained payment retry optimization machine learning model to a particular failed payment transaction to obtain a set of one or more optimal payment retry times for a subscriber segment to which the particular failed payment transaction relates, the set of one or more optimal payment retry times for the subscriber segment being based on event outcome trends observed for the subscriber segment associated with the particular failed event; and retrying the particular failed payment transaction at the one or more optimal payment retry times.

Any of the above-described method, system, and/or computer program product embodiments can be combined in any manner to obtain additional embodiments of the disclosed technology. In particular, any feature, component, aspect, or the like of a given embodiment can be combined with any other feature, component, aspect, or the like of any other embodiment to obtain another embodiment of the disclosed technology.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the disclosed technology are set forth with particularity in the appended claims. A better understanding of the features and advantages of the disclosed technology will be obtained by reference to the following detailed description that sets forth illustrative embodiments, in which the principles of the technology are utilized, and the accompanying drawings of which:

FIG. 1 is a block diagram that depicts an example network system that includes a multi-tenant system configured to provide cloud-based software-as-a-service (SaaS) services to multiple tenants in accordance with example embodiments of the disclosed technology.

FIG. 2 is a block diagram that depicts example components of a multi-tenant system configured to implement machine learning-based payment retry optimization techniques in accordance with example embodiments of the disclosed technology.

FIG. 3 is a block diagram that depicts a schematic representation of the training and refinement of a payment retry optimization machine learning model in accordance with example embodiments of the disclosed technology.

FIG. 4A is a block diagram that schematically depicts optimization of the timing of payment retry windows in accordance with example embodiments of the disclosed technology.

FIG. 4B is a block diagram that schematically depicts how changing the overall payment retry period can impact the optimized timing of payment retry windows in accordance with example embodiments of the disclosed technology.

FIG. 5 is a flowchart representing an illustrative method for training a payment retry optimization machine learning model and utilizing the trained model to determine optimal payment retry times for one or more tenant/subscriber segments in accordance with example embodiments of the disclosed technology.

FIG. 6 is a flowchart representing a specific implementation of the illustrative method depicted in the flowchart of FIG. 5 in accordance with example embodiments of the disclosed technology.

FIG. 7 depicts an example user interface for accessing configurable payment retry functionality in accordance with example embodiments of the disclosed technology.

FIG. 8 depicts an example user interface for selecting/modifying settings for a subscriber group in accordance with example embodiments of the disclosed technology.

FIG. 9 depicts an example user interface for defining/editing payment retry rules in accordance with example embodiments of the disclosed technology.

FIG. 10 depicts an example user interface for configuring parameters for machine learning-based payment retry optimization in accordance with example embodiments of the disclosed technology.

FIG. 11 is a block diagram depicting an example computing device that may form part of a computing system configured to implement features disclosed herein in accordance with example embodiments of the disclosed technology.

### DETAILED DESCRIPTION

Payment transactions can fail for a variety of reasons. For instance, a bank account may have insufficient funds or the available credit on a credit card may be insufficient to cover the payment amount. In other example scenarios, a payment transaction may fail due to suspected fraud, a lost/stolen card, technical issues affecting a payment processing gateway, failure to provide correct information linked to a payment card (e.g., name, address, etc.), and so forth. Failed payments can negatively impact revenue and cause unwanted customer churn for any business, but can be particularly harmful to a subscription-based business that relies on repeated, periodic billing and payment collection to ensure sufficient operating cash flow from recurring revenue. Further, recovery costs associated with attempting to collect on an unpaid invoice can ultimately amount to a sizeable percentage of the underlying amount due, and with the chances of recovery generally being slim, such collection efforts can end up costing more than the amount due. To mitigate the effects of unpaid invoices, a business that offers goods and/or services on a subscription basis may seek to collect more cash up front by, for example, increasing the number of annual subscriptions relative to the number of monthly subscriptions. While this may help to lessen the hit to recurring revenue from failed payments, it does little to prevent and may in fact exacerbate customer churn, because customers are generally less likely to commit to annual subscriptions as compared to monthly subscriptions.

A service provider may attempt one or more retries of a failed payment transaction. In some cases, a payment transaction that initially fails may ultimately succeed at a later point when retried. For instance, a payment transaction that fails due to insufficient bank funds, may succeed if retried at a later time when an amount of funds sufficient to cover the transaction are present in the funding account (e.g., after a paycheck is deposited). As another non-limiting example, if a payment transaction initially fails due to a credit card being locked for suspected fraud, that transaction may later succeed when retried after the fraud lock has been removed. In some scenarios, a failed payment transaction may have essentially no chance of future success if retried, such as in the case of a lost credit card that has been canceled and replaced with a new credit card and thus new credit card data.

Execution of a payment transaction involves a series of exchanges between a payor system, a payment processor system, and a financial institution system. During processing of a payment transaction, a payment processor may submit a payment request to a payment gateway. The payment gateway may return a response code that indicates success or failure of the payment transaction. When a payment transaction fails, the response code is a failure code that indicates a reason the payment failed such as due to insufficient funds, suspected fraud, a lost credit card, or the like. While different payment gateways generally use different sets of response codes, together the different codes represent overlapping semantic failure type categories. For instance, different payment gateways may use different failure codes to represent the same basis for failure (e.g., failure due to suspected fraud on a credit card). Further, in many instances, a payment gateway may use multiple response codes to represent different variations of the same general type of failure. For example, a payment gateway may use a different failure code for suspected credit card fraud depending on who the credit card issuer is.

In some instances, the failure code associated with a failed payment transaction may point to the likelihood of success or failure of a retry of the payment transaction. More specifically, the various failure codes observed across payment gateways may be classified broadly into the following categories: “success,” “hard decline,” “soft decline,” or “system error.” Payments that are successfully processed can be grouped in the “success” category. Failed payments which have little to no chance of success upon retry can be grouped into the “hard decline” category, while payments which have at least a threshold probability of success upon retry can be grouped into the “soft decline” category. An example of a “hard decline” may be a payment failure due to a lost/stolen credit card, which has no chance of success due to cancellation of the card account. An example of a “soft decline” may be a payment failure for lack of sufficient funds, which has a chance of success upon retry when additional funds are deposited into the funding account, for example. A “system error” payment failure may occur as a result of a payment processing error that is unrelated to the validity of the form of payment used or to the availability of funds/credit sufficient to cover the payment amount. For instance, a “system error” code may indicate a payment failure due to a server timeout at the payment gateway. “System error” failed transactions may have a high likelihood of success upon retry, as the underlying technical issue that caused the failure is likely to be transient.

Thus, the category type to which a payment gateway response code belongs can indicate, at least in part, a relative likelihood of success of retrying the corresponding failed payment transaction, ranging from little to no chance of success with the “hard decline” type, to a greater chance of success with the “soft decline” type, and to a substantially higher likelihood of success for the “system error” type. It should be appreciated that the above-described failure type categories are merely illustrative and not exhaustive. As a non-limiting example of a possible variation to the above-described failure type categories, in some embodiments, the “soft decline” category may include multiple sub-categories or tiers corresponding to different probabilities of success upon retry of a failed payment transaction. For example, a first payment transaction that fails due to insufficient funds may have a greater likelihood of success upon retry than a second payment transaction that fails due to suspected fraud. As such, in some embodiments, the first payment transaction may be categorized into a “soft decline” tier 1 sub-category and the second payment transaction may be categorized into a “soft decline” tier 2 sub-category, where the tier 1 sub-category encompasses a range of probabilities of success upon retry that are greater than the range covered by the tier 2 sub-category.

As previously noted, the SaaS services provided to tenants in a multi-tenant computing environment can include subscription billing services. In particular, a tenant (e.g., an enterprise customer) may rely on SaaS functionality of a multi-tenant computing system to manage the subscription billing of the tenant's subscriber base, which could potentially include millions of subscribers. Subscription billing SaaS functionality may include, without limitation, invoice generation, payment scheduling, payment transaction initiation, failed payment retry, collection activities, and the like. In some embodiments of the disclosed technology, the subscription billing SaaS functionality provided by the multi-tenant computing system may further include a configurable payment retry feature that enables a tenant to customize payment retry strategies based on payment gateway response codes.

More specifically, in some embodiments, the configurable payment retry feature allows a tenant to customize payment retry strategies based on the failure type category of a failed payment transaction. In some embodiments, payment retry strategies may be fully or partly automated (the strategies being based on the failure type category of a failed payment transaction). In some embodiments, a customized payment retry strategy may include various constraints including, for example, a maximum number of payment retries that can be attempted and an overall time period over which the payment retries can be attempted. In some embodiments, a customized payment retry strategy specifies a respective time at which each payment retry should occur within the overall payment retry period, i.e., a timing schedule and/or time of day for the payment retries. In some embodiments, a different payment retry timing schedule may be specified for different payment failure type categories. For example, a first timing schedule may be specified for a “soft decline” failed payment transaction versus a second, different timing schedule for a “system error” failed transaction. The first and second timing schedules may differ with respect to the individual times at which the payment retries are attempted, the amount of waiting time in between consecutive payment retries, and so forth. Moreover, different overall payment retry windows and/or different maximum numbers of payment retries may be specified for payment transactions categorized into different failure type categories or sub-categories.

Empirical data indicates that the timing of a retry of a failed payment transaction can impact the likelihood of success or failure of the retry. For instance, payment transactions generally, and retries of failed payments in particular, may have a greater likelihood of success if initiated at a time that takes into account the geographic location/time zone of the subscriber. While the configurable payment retry feature described above may allow a tenant to specify when payment retries should occur over the course of an overall payment retry window, one technical problem overcome by embodiments of the disclosed technology is determining the times most optimal for attempting payment retries. Without the support of embodiments of the disclosed technology, tenants may be left to set up various test scenarios and experiment with different payment retry timing strategies to identify which times may result in an increased likelihood of success for a failed payment retry. In particular, a tenant's collections team may spend an inordinate amount of time analyzing payment outcome data and configuring payment retry settings in an attempt to identify times that improve the chance of success of a payment retry. Even then, a collections team is unlikely to be able to analyze the payment outcome data at a granularity needed to identify patterns/trends in the data at a tenant level, a subscriber group level, and/or at an individual subscriber level.

Example embodiments of the disclosed technology solve the above-mentioned technical problem by leveraging machine learning-based techniques to determine an optimal timing schedule for retries of a failed payment transaction. More specifically, example embodiments of the disclosed technology train a payment retry optimization machine learning model using ground-truth payment outcome data to obtain a trained model configured to identify an optimal timing schedule for one or more retries of a failed payment transaction based on various inputs including a time of the failed payment transaction and a set of payment attributes. A failed payment retry timing schedule refers to a sequence of times at which a failed payment transaction is once again attempted (i.e., retried) or a sequence of time windows in which such retries can be attempted.

In some embodiments, the ground-truth payment outcome data may include data relating to historical payment transactions; data relating to payment attributes of the historical transactions; data relating to the number/timing of retries of those historical transactions that failed; payment success/failure data including data indicating whether a retry of a failed payment was successful or not; and so forth. The payment attributes represented in the training dataset may include a number of different characteristics of a payment transaction including, without limitation, payment time, payment gateway, payment method type, account age, payment amount, and so forth. Additional example payment attributes will be described in more detail later in this disclosure.

In some embodiments, training the payment retry optimization machine learning model may include identifying, based on the ground-truth payment outcome data, payment outcome trends across the subscribers of multiple tenants. For example, training the payment retry optimization machine learning model may reveal that a retry of a failed payment has a greater likelihood of success if attempted during a particular time period such as during business hours for the time zone of the geographic location of the particular subscriber to whom the payment transaction is linked. Thus, in some embodiments, the trained model may schedule payment retries based on the time zone of the geographic location of the individual subscriber regardless of the tenant with whom the subscriber is associated if, for example, the trend noted above is consistently observed in the ground-truth payment outcome data for multiple tenants.

In some embodiments, as the trained payment retry optimization machine learning model is used to implement a payment retry strategy for a particular tenant and continues to ingest additional payment outcome data for the particular tenant, the model may become more refined and capable of identifying tenant-specific patterns/trends for failed payment retries for subscribers of that particular tenant. For example, as the model ingests more payment outcome data specific to a particular tenant, it may determine that the likelihood of success of a retry of a failed payment is improved (for the subscribers of this particular tenant) if the retry is attempted at least a tenant-specific threshold amount of time after the initial failed payment, which may be a longer or a shorter duration of time than the optimal waiting times the model identifies for other tenants. As a non-limiting example, the subscriber base for this particular tenant may be weighted towards a younger demographic than the subscriber bases of other tenants, which may influence the optimal timing of payment retries. More particularly, a younger demographic may be more likely to fund their payment accounts at particular times of the month, which may be linked to when they receive their paychecks. For example, a younger demographic may be more likely to use direct deposit or may be more likely to maintain a smaller buffer of available funds in their funding accounts, and thus, may be more likely to have sufficient funds in their accounts on specific dates/date ranges each month such as during a window of time that immediately follows dates on which the accounts are periodically funded. This, in turn, may influence the optimal timing for failed payment retries. For example, a failed payment transaction may be more likely to succeed for a younger demographic if retried shortly after an expected account funding date.

In some embodiments, as the payment retry optimization machine learning model is trained, it may categorize subscribers within a given tenant and/or subscribers across multiple tenants into one or more subscriber groups based on payment outcome data for the subscribers, in particular, based on the historical success/failure rates of retries of failed payment transactions in relation to the historical timing of such retries. More specifically, subscribers of a given tenant or subscribers across multiple tenants may be categorized into a subscriber group if the historical payment outcome data for the subscribers reveals that a particular failed payment retry timing schedule is optimal for the subscribers as compared to other potential retry timing schedules such as those which may be applied to other subscriber groups. An optimal failed payment retry timing schedule may be one that maximizes a likelihood of ultimate success of retries of the failed payment transaction given a set of constraints such as an overall time period over which the retries can be attempted and a maximum number of retries permitted.

In some embodiments, the payment retry optimization machine learning model may categorize a single subscriber of a particular tenant into his/her own category for the purposes of applying a failed payment retry timing schedule that is unique to that particular subscriber. As such, in some embodiments, the trained payment retry optimization machine learning model is capable of determining optimal timing for failed payment retries at a granularity down to the account holder level (the terms subscriber and account holder may be used interchangeably herein). For instance, the payment outcome data relating to a single subscriber may indicate failed payment retry outcomes that are specific to that particular subscriber, and which may therefore, warrant application of a retry timing schedule that is uniquely tailored to that subscriber.

As a non-limiting example, assume that an account holder is a small business owner (e.g., a sole proprietorship, an independent contractor, etc.) who is not paid at regular, periodic intervals as a typical waged employee would be. Further assume that although not being paid at regular intervals, there is nonetheless a pattern to the payments the account holder receives, and consequently, a pattern to when the account holder's funding account is funded with the deposited payments. For example, the account holder may receive payments earlier in the month during a peak season but may receive payments later in the month during an off-peak season. An optimal payment retry timing schedule specifically tailored for this subscriber may modify the timing of failed payment retries based on whether it is the peak season or off-peak season in an attempt to increase the likelihood that the timing of the retries allows enough time for expected funds to be deposited into the account, thereby increasing the chance of ultimate success of the failed payment transaction. Stated another way, the trained payment retry optimization machine learning model may determine that this particular account holder exhibits sufficiently distinct historical payment outcome trends to warrant categorizing the subscriber into a new subscriber group to which a unique optimal failed payment retry timing schedule is applied that is sufficiently different from other optimal retry timing schedules applied to other existing subscriber groups.

In some embodiments, data indicative of subscriber groups identified by the payment retry optimization model during training may be stored as tenant/subscriber segment data. A tenant/subscriber segment, as that term is used herein, may encompass subscriber groups of varying levels of granularity. For instance, an example tenant/subscriber segment may be a cross-tenant subscriber group that includes all subscribers across of all tenants or some subset of subscribers from each tenant. Another example of a tenant/subscriber segment is a subscriber group that includes all subscribers of a particular tenant. Yet another example of a tenant/subscriber segment is a subscriber group that includes some subset of subscribers of a particular tenant based on one or more shared characteristics/attributes of the subset of subscribers. An example of such a subscriber group is all male subscribers of a particular tenant who are 20-30 years old. Still another example of a tenant/subscriber segment is an individual subscriber, who may be an account holder with one or more tenants.

In some embodiments, the trained machine learning model may output different optimal timing schedules for different tenant/subscriber segments. In some embodiments, there may be a hierarchy associated with the tenant/subscriber segments that extends from a cross-tenant subscriber group that includes all subscribers across all tenants (at a highest level of generality/a coarsest level of granularity) to a single-tenant subscriber group that includes all subscribers of the tenant, to a single-tenant subscriber group that includes only a subset of the subscribers of the tenant, and ultimately to an individual account holder/subscriber (at a lowest level of generality/a finest level of granularity). In some embodiments, for a given failed payment transaction for a given subscriber, the machine learning model may determine the lowest level in the tenant/subscriber segment hierarchy for which there is sufficient tenant/subscriber data relating to the subscriber, and may then output a timing schedule (for handling retries of the failed payment transaction) determined to be optimal for the related tenant/subscriber data.

For example, when a new tenant joins the multi-tenant environment and begins to receive subscription billing SaaS services, due to the dearth of available payment outcome data for the new tenant, the trained machine learning model may initially apply a timing schedule for retries of failed payment transactions of subscribers of the new tenant that was previously determined to be optimal for a cross-tenant subscriber group that includes all subscribers across all tenants. Stated another way, the machine learning model may initially apply a timing schedule for failed payment retries that corresponds to a highest level of generality. Then, as the machine learning model begins to ingest more payment outcome data for subscribers of the new tenant, the model may determine that the payment behavior for subscribers of the new tenant closely matches the known behavior of an existing tenant. In this case, the machine learning model may be configured to output payment retry timing schedules—previously determined to be optimal for subscribers of the existing tenant—for failed transactions of subscribers of the new tenant. As the model ingests even more payment outcome data for subscribers of the new tenant, the model may determine that the new tenant's subscribers exhibit payment behavior that differs from payment behavior exhibited by subscribers of other tenants to such an extent to cause the model to define a new subscriber group for subscribers of the new tenant and output a payment retry timing schedule optimized for the subscribers of the new tenant. In some embodiments, the process may continue in this manner as the model ingests more payment outcome data and learns more about individual subscribers of the new tenant, with the trained model outputting more refined payment retry timing schedules that are optimized for narrower subscriber groups of the new tenant, and ultimately, potentially outputting a payment retry timing schedule that is specific to an individual subscriber of the new tenant.

In some embodiments, when a new tenant joins the multi-tenant environment, the trained payment retry optimization machine learning model may determine whether a subscriber of the new tenant is one whose payment behavior is already known, i.e., whether there is existing tenant/subscriber data relating to the subscriber. This may be the case if, for example, the subscriber is also a subscriber of one or more existing tenants. In such an example scenario, as the model ingested payment outcome data for subscribers of the one or more existing tenants, and categorized the subscribers into one or more subscriber groups based on their payment behaviors, the model may have categorized the subscriber of the new tenant into an existing subscriber group (by virtue of the subscriber of the new tenant also being a subscriber of one or more existing tenants). Further, the machine learning model may have determined optimal timing data tailored to that existing subscriber group into which the subscriber of the new tenant had already been categorized, in which case, the model may select that timing data for retries of failed payments associated with the subscriber of the new tenant, rather than, for example, more generalized timing data applicable to a broader tenant/subscriber segment (e.g., all subscribers across all tenants). Stated another way, the payment retry optimization machine learning model may leverage existing knowledge it may have about a subscriber of a new tenant based on having previously ingested payment outcome data for the subscriber in connection with a subscription the subscriber has with another existing tenant. In particular, the machine learning model may leverage existing tenant/subscriber segment data indicative of categorization of the subscriber into a subscriber group to identify and apply optimal payment retry timing data learned for that subscriber group to retries of failed payments for the subscriber in connection with the new tenant.

In some embodiments, the trained model may learn to optimize aspects of a failed payment retry other than timing, such as the payment method type. For example, the trained model may learn to retry a failed payment using an alternative payment method type after some threshold number of retries using the initial payment method type fail. If, for example, subscribers of a particular tenant tend to include a younger demographic that generally prefers to use a third-party payment provider for payments as opposed to a credit card, the trained model may determine that a failed credit card transaction should be retried using an alternative payment method type (e.g., a third-party payment provider such as PayPal™) after some threshold number of retries are attempted using the original failed payment method type. In contrast, the payment method type may never be changed for failed payment retries for subscribers of other tenants or may be changed after a greater number of retries are first attempted using the original failed payment method type.

An overview of various example embodiments of the disclosed technology has been presented above. A more detailed discussion of these and other embodiments of the disclosed technology will now be provided. It should be appreciated the any embodiments individually described herein can be combined in any manner to yield additional embodiments of the disclosed technology. It should further be appreciated that discussion herein of one or more aspects of any particular embodiment shall not be construed as an admission that such aspect(s) are not also shared by other embodiments of the disclosed technology.

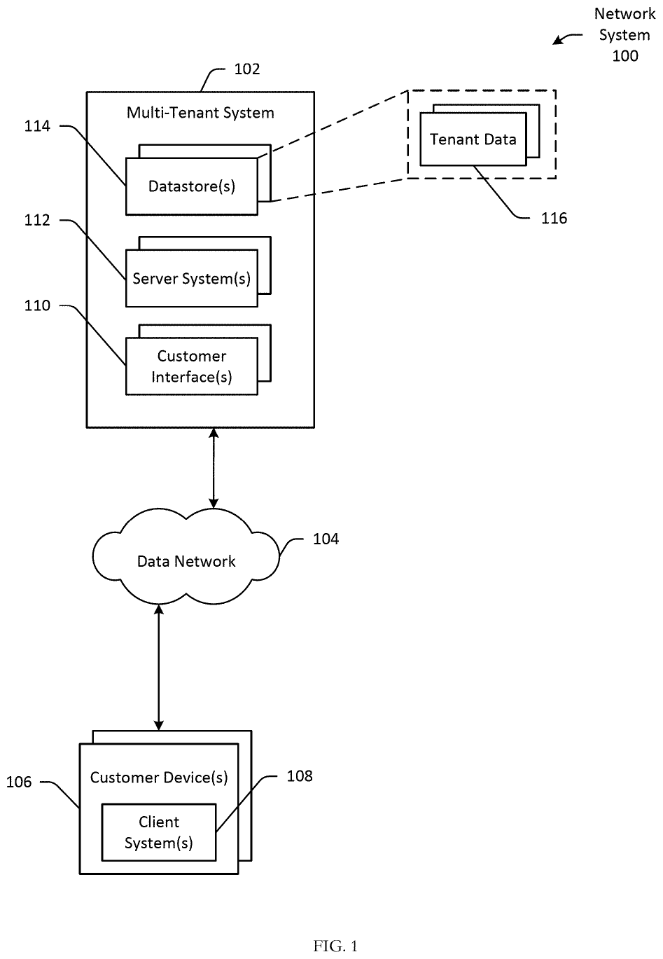

FIG. 1 depicts a diagram of an example network system 100 for providing cloud-based SaaS services of a multi-tenant system 102 to multiple tenants according to example embodiments. Examples of such cloud-based SaaS services include data storage, data processing, and business-oriented applications. In some embodiments, each tenant may be a subscription-based entity or provider (e.g., an internet service provider, a home security system and service provider, a cellular phone service provider, an entertainment content provider, etc.). A respective group of one or more users (e.g., individuals, business entities, customers of the business entities, systems, etc.) may share access to the cloud-based services provided to each tenant by the multi-tenant system 102. In some example embodiments, a tenant corresponds to a service entity such as AT&T™, Netflix™, Verizon™, and/or the like. In some example embodiments, a tenant may correspond to one or more products or services offered by an entity. For example, in an example embodiment, AT&T internet products and AT&T security products may be separate and distinct tenants. In some example embodiments, the cloud-based SaaS services relate to managing subscriber records, product and/or service consumption information, billing information, payment information, and/or the like.

The network system 100 includes the multi-tenant system 102 coupled via a data network 104 (e.g., a set of one or more public and/or private, wired and/or wireless networks) to client/customer devices 106. The multi-tenant system 102 includes shared resources for hosting the cloud-based SaaS services provided to the tenants. The shared resources may include processors, memory, virtual systems, services, application programs, load balancers, firewalls, and so forth. As depicted in FIG. 1, the multi-tenant system 102 may include tenant/customer interfaces 110, server systems 112, and datastores 114. Each of the client devices 106 may include a client system 108 that accesses the cloud-based SaaS services hosted by the multi-tenant system 102. In example embodiments, the client systems 108 may be operated by employees (e.g., administrator users) of the provider of the multi-tenant system 102; by employees of the tenants; and/or by end users of the tenants' services.

Each client device 106 may include a personal computing device such as a desktop computer, a laptop computer, a notebook, a tablet, a personal digital assistant (PDA), a smartphone, a wearable computing device, and/or any other consumer electronic device incorporating one or more computer components. The client system 108 on each client device 106 may include hardware, software, and/or firmware for communicating with the multi-tenant system 102 and accessing the cloud-based services hosted by the multi-tenant system 102. Examples of the client systems 108 may include, without limitation, web browsers, client engines, drivers, user interface components, proprietary interfaces, and so forth.

The multi-tenant system 102 may include hardware, software, and/or firmware for hosting cloud-based services for tenants. In example embodiments, the multi-tenant system 102 may offer access to shared resources including systems and applications on shared devices and may offer each tenant the same quality of service or may offer different tenants varying qualities of service. In some example embodiments, the multi-tenant system 102 may not use virtualization or instantiation processes. In some example embodiments, the multi-tenant system 102 may integrate several business computing systems into a common system with a view toward streamlining business processes and increasing efficiencies on a business-wide level.

In some example embodiments, the multi-tenant system 102 includes a user interface tier of multiple tenant interfaces 110, a server tier of multiple server systems 112, and a datastore tier of multiple datastores 114 for the multiple tenants. In some example embodiments, the tenant interfaces 110 may include graphical user interfaces and/or web-based interfaces to enable tenants to access the shared services hosted by the multi-tenant system 102. The tenant interfaces 110 may support load balancing when multiple tenants (and/or multiple customers of the tenants) attempt to access the multi-tenant system 102 concurrently. The tenant interfaces 110 may additionally or alternatively include an operator interface for use by a systems operator to configure or otherwise manage configuration settings or the like for the multi-tenant system 102. In some example embodiments, to support load balancing, each tenant may be associated with a subset of the total number of tenant interfaces 110.

In some example embodiments, the server systems 112 may include hardware, software, and/or firmware configured to host the shared services for tenants. The hosted services may include tenant-specific business services or functions, including enterprise resource planning (ERP) services; customer relationship management (CRM) services; eCommerce services; Human Resources (HR) management services; financial services including, for example, payroll services, accounting services, subscription billing services, financial reporting and analysis services, or the like; calendaring services; order processing services; inventory management services; supply chain management (SCM) services; collaboration services; sales force automation (SFA) services; marketing automation services; support services including, for example, contact list management services, call-center support services, web-based customer support services, or the like; partner and vendor management services; product lifecycle management (PLM) services; and so forth. Similar to the tenant interfaces 110, in some example embodiments, the server systems 112 may support load balancing when multiple tenants (and/or multiple customers of tenants) attempt to access the multi-tenant system 102 concurrently. Further, in some example embodiments, each tenant may be associated with a subset of the total number of server systems 112 to support load balancing.

In some example embodiments, tenant data 116 for each tenant may be stored in a logical store across one or more datastores 114. In some example embodiments, each tenant uses a logical store that is not assigned to any predetermined datastores 114. Each logical store may contain tenant data 116 that is used, generated, and/or stored as part of providing tenant-specific business services or functions. In some example embodiments, the datastores 114 may include relational database management systems (RDBMS), object-based database systems, or the like. In some example embodiments, tenant data 116 may be stored across multiple datastores 114, with each datastore dedicated to a particular service (e.g., managing customer records, managing product and/or service consumption information, managing billing information, managing payment information, etc.).

In some example embodiments, the tenant data 116 may include subscription information, such as billing data and/or subscription status data (e.g., active, canceled, suspended, re-activated). Billing data may include billing invoice data (e.g., date of invoices and invoice amounts, overage charge dates and overage charge amounts, etc.); payment transaction data (e.g., date of payments, amount of payments, etc.); payment outcome data (e.g., whether a payment was successful or failed, and if failed, the failure response code); failed payment retry data (e.g., the number of retries attempted for a failed payment, the overall retry window, the timing of the failed payment retries, whether the retries were ultimately successful or not, etc.); payment method data (e.g., stored credit card/debit card information); payment plan data (e.g., annual billing, monthly billing, etc.); and/or service plan data (e.g., the name of a service plan). Subscription information may also include a geographic region and/or location information associated with a tenant, service, and/or subscriber. In some example embodiments, the tenant data 116 may include usage data (e.g., account activity data), such as data identifying new subscriptions; changes to subscribed products and/or services; cancellation of one or more products and/or services; subscriptions to new products and/or services as part of an existing subscription; application of discounts; loyalty program package changes (e.g., additional programs and/or services, special rates, or the like for loyal customers); reduction or increase of rates for products and/or services; and/or cancellation of a subscription. In some example embodiments, account activity data may include data indicative of subscriber product usage data (e.g., what channels the subscriber actually watches, what services and what level of consumption the subscriber receives, quality of the product and/or services, etc.).

In some example embodiments, the tenant data 116 may be stored in one or more data formats according to one or more data schemas. For example, subscription tenant data may be stored in a particular format and usage tenant data may be stored in another format. As used herein, data formats, or simply formats, may include data types; variable types; protocols (e.g., protocols for accessing, storing, and/or transmitting data); programming languages; scripting languages; data value parameters (e.g., date formats, string lengths, etc.); endpoint locations; and so forth. In some example embodiments, the tenant data 116 may be stored as data objects as part of an object-oriented data schema. The tenant data 116 may include parent data objects, where each parent data object is related to one or more child data objects via a parent-child dependency relationship. Any given parent data object may, in turn, be a child data object to one or more other parent data objects. Similarly, any given child data object may, in turn, be a parent data object to one or more other child data objects. In some example embodiments, the tenant data 116 may include tabular data including one or more database tables and corresponding tabular data contained therein. Tabular data of the tenant data 116 may be linked to corresponding object data of the tenant data 116.

In some example embodiments, the multi-tenant system 102 functions to provide uniform access to disparate services (e.g., microservices) and/or disparate datastores. For example, different services of the multi-tenant system 102 may manage (e.g., create, read, update, delete) tenant data 116 stored in different datastores 114. It will be appreciated that as used herein, a “service” may be single service and/or a set of services (e.g., a cluster of services). The datastores 114 may store data in different formats and/or the services may handle data differently. The services may each include a service provider interface (SPI) that provides data from the service and/or that receives data at the service in a common (or uniform) format, regardless of the original format that may be used by the service and/or datastores 114. In some example embodiments, the multi-tenant system 102 may define a uniform access specification that defines the common format that the services must comport with when receiving and/or providing data. Accordingly, each of the services may be accessed in a uniform manner, and data may be consumed from the services in a uniform manner, regardless of the internal specifications and/or operations of the service.

The data/communication network 104 may represent one or more types of computer networks (e.g., a local area network (LAN), a wide area network (WAN), etc.) and/or underlying transmission media. The data network 104 may provide communication between the systems, engines, datastores, components, and/or devices described herein. In some example embodiments, the data network 104 includes one or more computing devices, routers, cables, buses, and/or other network topologies (e.g., mesh network topologies). In some example embodiments, the data network 104 may include one or more wired and/or wireless networks. In various example embodiments, the data network 104 may include the Internet, one or more WANs, one or more LANs, and/or one or more other public, private, Internet Protocol (IP)-based, and/or non-IP-based networks.

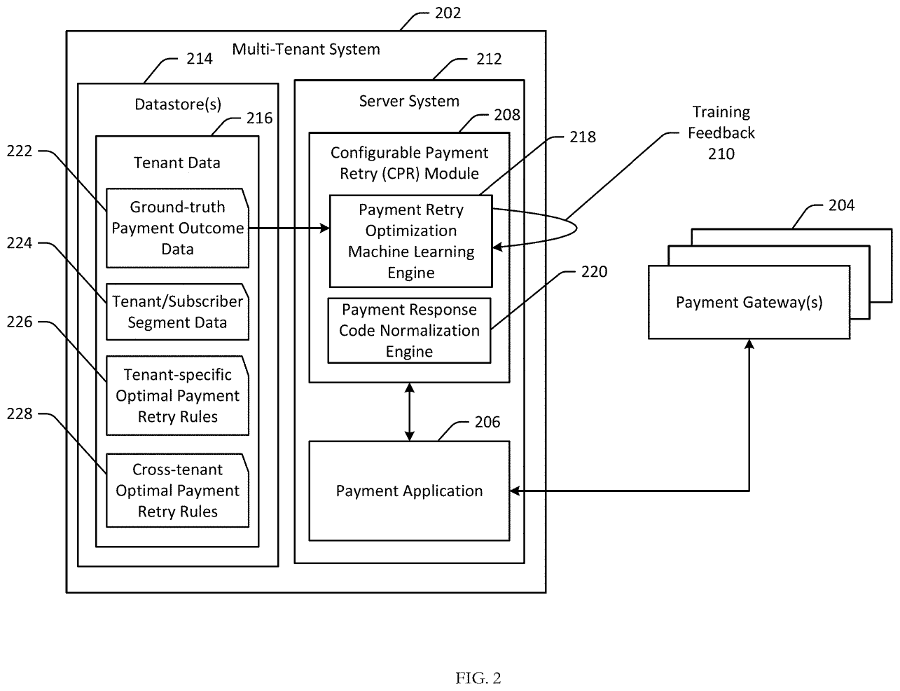

FIG. 2 depicts an example multi-tenant system 202 (which may be a particular implementation of the multi-tenant system 102 depicted in FIG. 1) and example components of the multi-tenant system 202 that are configured to implement machine learning-based payment retry optimization techniques in accordance with example embodiments of the disclosed technology. For illustrative purposes, the tenant data 216 may include at least a portion of the tenant data 116 (FIG. 1). The tenant data 216 may be stored in one or more datastores 214, which may represent at least a portion of the datastore(s) 114 (FIG. 1). In some embodiments, the tenant data 216 may include respective data for each of multiple tenants. The tenant data 216 associated with a given tenant may include data at the tenant level such as subscription/product offering data, terms and conditions data, or the like that is generally applicable across subscribers of the tenant. The tenant data 216 associated with a given tenant may further include data at the individual subscriber/account holder level such as user profile/subscription data, user preference data, payment-related data (e.g., stored payment methods, billing history, etc.), and so forth.

In some embodiments, the tenant data 216 may include ground-truth payment outcome data 222. The payment outcome data 222 may be provided as input to a payment retry optimization machine learning engine 218, which may be configured to train a payment retry optimization machine learning model based on the payment outcome data 222. The payment outcome data 222 may include data relating to historical payment transactions for subscribers of one or more tenants including successful payment transaction, failed transactions due to hard declines, failed transactions due to soft declines, and so forth. The payment outcome data 222 may include data for tenants of all sizes and types including business-to-business (B2B) tenants and business-to-consumer (B2C) tenants; tenants across different industries; tenants/subscribers based in various countries; and so forth. The payment outcome data 222 may further include data relating to payment attributes of the historical transactions; data relating to the number/timing of retries of those historical transactions that failed; payment success/failure data indicating whether a retry of a failed payment was successful or not; payment success/failure data indicating a number of retries attempted for a failed transaction before ultimate success of the payment or a number of unsuccessful retries attempted prior to expiration of an overall payment retry window; and so forth. It should be appreciated that the above-described examples of the types of data which may be included among the ground-truth payment outcome data 222 are illustrative and not exhaustive.

The ground-truth payment outcome data 222 may further include data indicative of various payment attributes for each payment transaction represented in the data 222. The payment attributes may include a number of different characteristics of a payment transaction including, for example, payment date/time which may be a time of the day, a day of the week, a day of the month, and/or the like. In some embodiments, the timing of the payment transaction may be represented in the payment outcome training data 222 as truncated harmonic series including sequences of sine and cosine transformations of raw time values. Representing payment timing in this manner may assist the machine learning model in understanding the temporal proximity of 11:59 PM and 12:01 AM, for example.

The payment attributes of a transaction may further include, without limitation, payment gateway; payment method type; account age; payment amount; monthly recurring revenue (MRR) for a user account with which the payment transaction is associated; a payment response code for the payment transaction (i.e., either a success code if the payment was successful or a failure code indicating a reason for the failure); a payment response code associated with one or more prior payment transactions involving the same payment gateway, payment method type, payment method, and/or account holder (such prior payment transactions may include a failed payment transaction and/or a retry of the failed transaction); a date and time of the prior payment transaction(s); a currency in which the payment is transacted; a country with which the payment method is associated; a number of previous consecutive failures (or failures over some lookback window) for the same payment method; a number of historical failed payments for the same payment method; a number of historical payments processed using the same payment method; the payment method expiration date; and so forth.

In some embodiments, in addition to the example payment attributes identified above for individual payment transactions, the payment outcome data 222 may further include data representing aggregate payment attributes. Such aggregate payment attributes may include, for example, a number of historical failed payment transactions involving a particular payment method type and/or a particular payment gateway (at an individual subscriber level, a tenant level, or across multiple tenants). As another non-limiting example, an aggregate payment attribute may include a historical number of retries attempted for failed payment transactions involving a particular payment method type and/or payment gateway (again this can be at an individual subscriber level, a tenant level, or across multiple tenants). It should be appreciated that the above examples of payment attributes and aggregate payment attributes are illustrative and not exhaustive.

As previously noted, the ground-truth payment outcome data 222 may be provided as input to the payment retry optimization machine learning engine 218, which in turn, may train a machine learning model to learn optimal timing for retries of a failed payment transaction based on the payment outcome data 222. In some embodiments, the only tunable parameter for a retry of a failed payment transaction is the timing of the retry, while other attributes of the original failed transaction remain the same (e.g., payment method type, payment gateway, currency, etc.). Accordingly, The payment outcome data 222 may include data for both successful payment transactions and failed payment transactions. This may serve to increase the size and density of the training dataset as well as the coverage of timing signals for successful transactions to assist the machine learning model in the learning process. Data for both successful and failed payment transactions may be included in the training dataset based on the assumption that the effect of the timing of a payment transaction on its probability of success is independent of the previous payment's success or failure. As such, including both successful and failed payments in the training dataset increases the diversity of timing signals without having to be concerned about dependencies among payments.

In some embodiments, the payment outcome data 222 may be divided into a training dataset used to train the payment retry optimization machine learning model and a test dataset used to evaluate performance of the trained model. In some embodiments, the training dataset may be larger than the test dataset. In some embodiments, the payment outcome data 222 may be divided such that all of the test data occurs after all of the training data. That is, the test dataset may correspond to payment transactions that are initiated/occur after the payment transactions in the training dataset. This may be done to prevent data from the test dataset leaking into the training dataset. In some embodiments, the training dataset and the test dataset may be disjoint to avoid evaluating the trained model on the same data used to train the model, which can indicate model performance that is better than what is actually achievable.

After the model is trained, it can be used to make predictions as to which payments in the test dataset failed or succeeded. In some embodiments, the performance of the model may be evaluated by analyzing the Area Under the Curve of the Receiver Operating Characteristic (AUC). AUC may be used because it is robust to the relative size of the two groups (successful payments and failed payments) that the model attempts to classify. Intuitively, in some embodiments, AUC calculates the probability that, given one payment randomly chosen from the set of successful payments and one payment chosen from the set of failed payments, the model will correctly rank the successful payment as more likely to be successful. AUC ranges between 0 and 1, with 1 being a ideal score.

In some embodiments, the payment retry optimization machine learning model may take the form of a machine learning algorithm that learns to approximate a conditional probability distribution that outputs a probability of success of a payment transaction given a time of the transaction and a vector of payment attributes associated with the transaction. The vector of payment attributes may include any of those previously described. Once the machine learning algorithm is trained to approximate the conditional probability distribution, a further optimization may be performed to determine, for any given invoice, an optimal time for initiating a payment transaction for that invoice such as an optimal time for attempting a retry of a failed payment transaction. The optimal time may be a time that maximizes the conditional probability distribution, or more specifically, the probability of success of a payment transaction (e.g., a retry of a failed payment) given a corresponding set of payment attributes. Stated more generally, the trained payment retry optimization machine learning model may learn to predict whether a payment with a given set of attributes will be successful or not, and may further learn which payment attributes tend to signify a successful transaction or a failed transaction.

In some embodiments, the trained machine learning model generated by the payment retry optimization machine learning engine 218 may learn various subscriber groups based on the payment outcome behavior observed for subscribers. For instance, the trained model may segment subscribers into different subscriber groups based on geographic location if it observes that the probability of success of a failed payment retry depends, at least in part, on the timing of the payment retry in relation to a time zone of a subscriber's geographic location. Thus, in some embodiments, subscribers may be grouped according to geographic region based on time zone differences between the regions (e.g., one subscriber group for subscribers residing in areas under the U.S. Pacific time zone, another subscriber group for subscribers residing in areas under the U.S. Central time zone, still another subscriber group for subscribers residing in areas under the U.S. Eastern time zone, and so forth). In some embodiments, subscriber groups based on different geographic regions/time zones may only be formed if there is at least a threshold time difference between the time zones. For example, a geographic region-based subscriber group may include all subscribers residing in the contiguous United States, another subscriber group may include subscribers residing in Hawaii, and yet another subscriber group may include subscribers residing in Europe.

In some embodiments, an optimal timing for a payment retry may be based on the geographic region associated with a subscriber group as well as the time of day at which the payment retry is attempted. For instance, the trained machine learning model may learn over time, based on the payment outcome training data 222, that payments that are attempted during typical business operating hours of the time zone of the geographic region of the subscriber are more likely to succeed, and may further learn that payments that are attempted from 8-10 AM in the local time of the subscriber are more likely succeed than payments attempted at other times regardless of the time zone of the geographic region of the subscriber. Based on this learned knowledge, payment retries may be attempted for multiple subscribers in different geographic regions during a same time window relative to the local time zones of the different geographic regions.

It should be appreciated that a subscriber group based on a geographic location/time zone of a subscriber's residence is merely an example type of subscriber group that can be formed. More generally, subscriber groups may be formed for any group of subscribers (for a single tenant or across multiple tenants) whose payment outcome behavior (e.g., likelihood of success/failure of a failed payment retry) is impacted in a similar manner as a result of one or more shared characteristics. For example, subscriber groups may be formed based on various subscriber demographics such as age, income levels, and so forth. For instance, a subscriber group may include subscribers who are aged 20-30 years old, another subscriber group may include subscribers who are aged 30-40 years old, and so forth. If, for example, a greater likelihood of failed payment transactions, a greater average number of retries of failed payments, or the like is observed for younger subscribers (e.g., aged 20-30 years old), they may be segmented into their own group, and payment retry strategies learned by the trained machine learning model and specifically tailored for that group can then be applied. For example, the trained machine learning model may determine, for younger subscribers, that retries of failed payments should be attempted at different times of the month based on the particular month.

In some embodiments, a subscriber group may include all subscribers of a particular tenant, and as such, may be thought of as a tenant group. For example, if all subscribers of a particular tenant demonstrate payment outcome behavior that is distinct from the payment outcome behavior of subscribers of other tenants (e.g., a same pattern/trend relating to the effect of the timing of failed payment retries on the ultimate success of the payment transaction), then a tenant group may be formed that includes all subscribers of that particular tenant. Further, in some embodiments, subscribers may be segmented into cross-tenant groups that includes subscribers associated with different tenants. While subscriber groups have been described as being automatically learned during training of the machine learning model, in certain embodiments, a tenant may be provided with the capability to specify its own subscriber groups. The tenant can then specify custom-tailored payment retry strategies for the groups it defines or can rely on the trained model to learn retry strategies over time for the tenant-specified groups.

In some embodiments, subscriber groups learned by the trained machine learning model as well as any groups specified by tenants may be stored as tenant/subscriber segment data 224. In particular, the tenant/subscriber segment data 224 may include data identifying a subscriber as belonging to one or more subscriber groups, data identifying the parameters/characteristics that define each subscriber group, and so forth. In some embodiments, a particular subscriber may belong to multiple subscriber groups. For instance, a subscriber may be segmented into a first subscriber group based on the subscriber's geographic location, another subscriber group based on her age, yet another subscriber group based on her income level, and so forth. In some embodiments, each subscriber group may be linked to a corresponding unique identifier, and a subscriber may be identified as belonging to a subscriber group via a stored association between the corresponding identifier of the group and a unique identifier of the subscriber (e.g., a database identifier for the subscriber, a name of the subscriber, a government-issued identifier, etc.).

In some embodiments, failed payment retry strategies identified by the trained payment retry optimization machine learning model may be stored as rulesets in the datastore(s) 214. More particularly, the failed payment retry strategies may include tenant-specific optimal payment retry rules 226 and cross-tenant optimal payment retry rules 228. The tenant-specific optimal payment retry rules 226 may specify optimal failed payment retry times that are specific to particular tenants, while the cross-tenant optimal payment retry rules 228 may specify optimal failed payment retry times that are applicable to subscribers across multiple tenants. In some embodiments, the tenant-specific optimal payment retry rules 226 and/or the cross-tenant optimal payment retry rules 228 may specify a respective optimal failed payment retry timing schedule for each subscriber group defined in the tenant/subscriber segment data 224. An optimal failed payment retry timing schedule applicable to a particular subscriber group may specify the times at which retries are to be attempted for a subscriber in the subscriber group, given initial input parameters of an overall payment retry window and a maximum number of retries permitted to be attempted.

In other embodiments, rather than being specific to a particular subscriber group, an optimal failed payment retry timing schedule may be specific to an individual subscriber. As previously described, the trained machine learning model may determine the optimal retry times based on a vector of payment attributes associated with the particular failed payment transaction. As the machine learning model ingests more payment outcome data relating to an individual subscriber, the trained model may output, for a given set of payment attributes, a retry timing schedule that is specific to that individual subscriber based on the historical payment attributes observed for the subscriber.

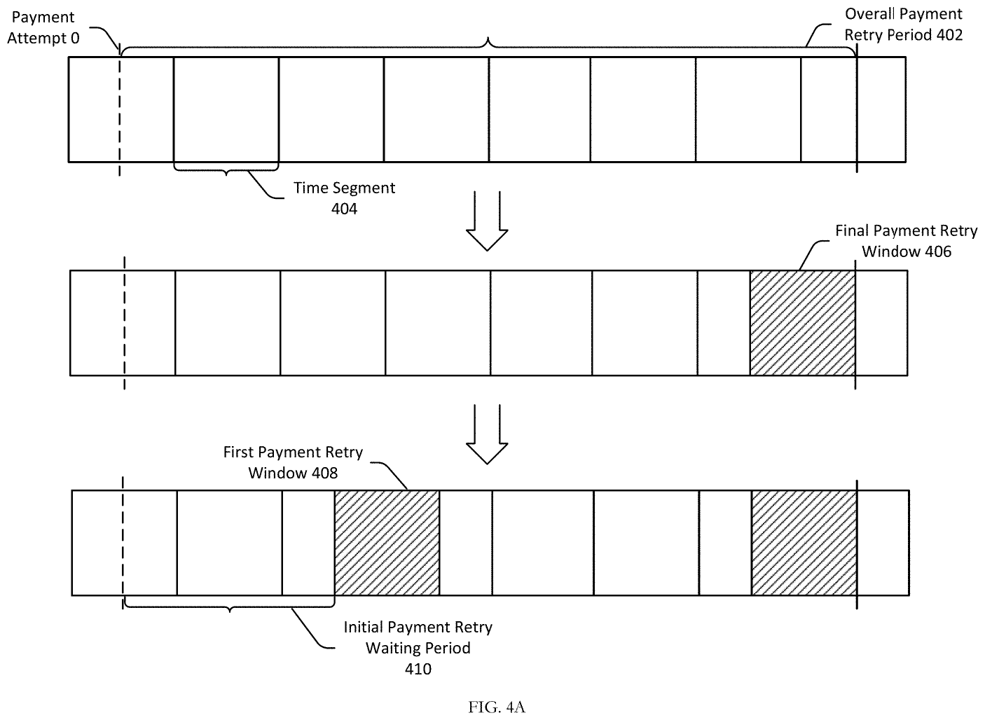

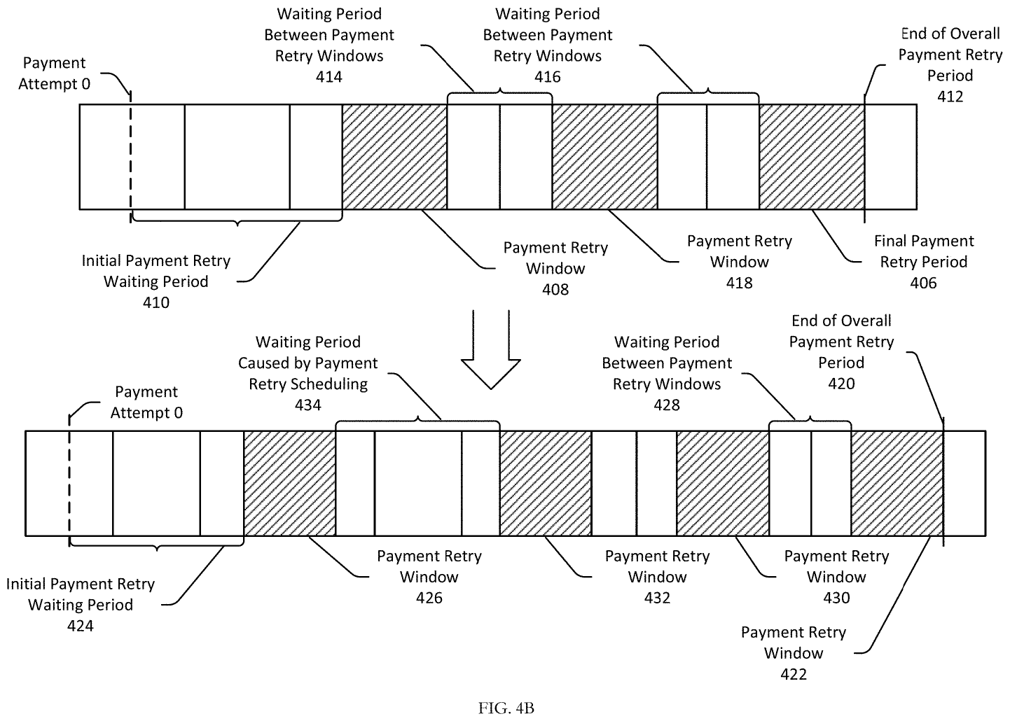

As previously noted, a subscriber may belong to multiple subscriber groups, each of which, in turn, may be associated with a corresponding set of tenant-specific optimal payment retry rules and/or a corresponding set of cross-tenant optimal payment retry rules. Further, a subscriber group to which a subscriber belongs may be a subset of another subscriber group to which the subscriber belongs. In some embodiments, the failed payment retry timing schedule applied to a failed payment transaction for a particular subscriber may be determined by the retry rules that are applicable to the lowest-level segmented group to which the subscriber belongs. More specifically, assume, for example, that a subscriber is part of a first subscriber group that includes all subscribers of a particular tenant who are located in North America, and is also part of a second subscriber group that includes all subscribers of the tenant who are located in the U.S. Pacific time zone. Assume further that different optimal payment retry timing schedules are associated with these subscriber groups. In some embodiments, the timing schedule corresponding to the second subscriber group may be applied for failed payment transactions for the subscriber because the second subscriber group has a narrower scope than the first subscriber group. Further, in some embodiments, a subscriber may be part of different subscriber groups, where one group is not a subgroup of another group, and where there may or may not be overlap in the subscribers of the two groups. In such example embodiments, the trained machine learning model may select a timing schedule corresponding to the subscriber group in which the particular set of payment attributes associated with the failed payment to be retried is historically more likely to be represented. An example of a specific implementation of a failed payment retry timing schedule will be described in more detail later in this disclosure in reference to FIGS. 4A and 4B.

In some embodiments, when a new tenant (e.g., Tenant A) joins the multi-tenant environment and begins to receive subscription billing SaaS services, due to the dearth of available payment outcome data for Tenant A, the trained machine learning model may initially apply a timing schedule for retries of failed payment transactions of subscribers of TenantA that was previously determined to be optimal for a cross-tenant subscriber group that includes all subscribers across all tenants. Stated another way, the machine learning model may initially apply a timing schedule for failed payment retries that corresponds to a highest level of generality. Then, as the machine learning model begins to ingest more payment outcome data for subscribers of Tenant A, the model may determine that the payment behavior for subscribers of Tenant A closely matches the known behavior of an existing tenant (Tenant B). For instance, Tenants A and B may both by streaming content service providers. In this case, the machine learning model may be configured to output payment retry timing schedules—previously determined to be optimal for subscribers of Tenant B—for failed transactions of subscribers of Tenant A. As the model ingests even more payment outcome data for subscribers of Tenant A, the model may determine that Tenant A's subscribers exhibit payment behavior that differs from payment behavior exhibited by subscribers of other tenants to such an extent to cause the model to define a new subscriber group for subscribers of Tenant A and output a payment retry timing schedule optimized for the subscribers of Tenant A. In some embodiments, the process may continue in this manner as the model ingests more payment outcome data and learns more about individual subscribers of Tenant A, with the trained model outputting more refined payment retry timing schedules that are optimized for narrower subscriber groups of Tenant A, and ultimately, potentially outputting a payment retry timing schedule that is specific to an individual subscriber of Tenant A.

Still referring to FIG. 2, the payment retry optimization machine learning engine 218 may form part of a configurable payment retry (CPR) module 218. The CPR module 218 may reside on a server system 212, which may be a particular implementation of the server system(s) 112. The CPR module 218 may be configured to provide configurable payment retry functionality to tenants of the multi-tenant system 202. The configurable payment retry functionality may include, for example, the capability to define subscriber groups, the capability to specify different failed payment retry timing schedules for different subscriber groups, the capability to specify different failed payment retry timing schedules for different failure code response categories, and so forth. For instance, as previously noted, in some embodiments, the set of all payment response codes returned by payment gateways may be broadly categorized among a “hard decline” category, a “soft decline” category, and a “system error” category. The CPR module 208 may provide functionality that enables a tenant to specify a failed payment retry timing schedule that is specific to the particular failure code category into which the payment gateway response code returned for the failed transaction was categorized. In some embodiments, the payment retry optimization machine learning engine 218 provides enhanced functionality to the CPR module 208 in the form of a trained machine learning model configured to identify optimal payment retry times that are tailored to the particular set of payment attributes associated with the failed payment transaction, and which, in turn, may be specific to a particular subscriber group or even an individual subscriber.

In some embodiments, the CPR module 208 may further include a payment response code normalization engine 220. Payment gateways 204 may utilize potentially hundreds of different payment response codes to represent the set of all possible reasons that a payment transaction can fail. In some embodiments, a given payment gateway 204 may utilize different response codes representing different bases for failure of a payment transaction (e.g., a code for a failed transaction due to a lost/stolen credit card versus a different code for failure due to an expired credit card). Further, in some embodiments, a given payment gateway 204 may utilize multiple response codes to represent different variations of the same underlying reason for failure of a payment transaction. For instance, a payment gateway 204 may utilize a different response code for each transaction failure due to insufficient funds in a funding account, depending on the financial institution with which the funding account is held. As another non-limiting example, a payment gateway 204 may utilize a different response code for different variations of failure of a payment transaction due to a lost/stolen card. For instance, a payment gateway 204 may use a first code indicating that a credit card cannot be accepted due to the potential that the card has been lost or stolen and a second different code if the card has, in fact, been reported as being lost or stolen. Moreover, in some example scenarios, a payment gateway 204 may use a different code for a failed transaction due to a credit card that has been reported as lost as compared to a failed transaction due to a credit card that has been reported as stolen. It should be appreciated that the above examples of failure codes that can be used to represent different reasons for failure of a payment transaction are illustrative and not exhaustive.

While different payment gateways 204 may use different sets of payment response codes having different formats/schema, together they cover the same semantic space. Stated another way, even though different payment gateways 204 may use different sets of payment response codes to represent different reasons for failure of a payment transaction, the set of codes utilized by one payment gateway represents the same finite set of possible bases for failure of a payment transaction as another set of codes utilized by another payment gateway. As such, in some embodiments, the payment response code normalization engine 220 may be configured to normalize the respective sets of failure response codes returned by the different payment gateways 204 to a uniform set of failure response codes. In some embodiments, this may involve the categorization of failure response codes into the various failure response code categories described earlier (e.g., “hard decline” versus “soft decline” versus “system error). In other embodiments, the payment response code normalization engine 220 may be configured to generate a set of uniform failure response codes and map each failure code utilized by each payment gateway 204 to one of the uniform failure codes (including a uniform failure code format).

As an example, the payment response code normalization engine 220 may determine that a first failure code associated with a first schema used by a first payment gateway and a second failure code associated with a second, different schema used by a second payment gateway correspond to the same failure type category (i.e., the first and second failure codes represent the same underlying reason for failure of the payment transaction), in which case, the normalization engine 220 may map the first and second failure codes to a same uniform failure code. For instance, a first payment gateway may return a first failure code for a lost/stolen credit card transaction and a second payment gateway may return a second, different failure code for a lost/stolen credit card transaction, in which case, the normalization engine 220 may map both the first failure code and the second failure code to a uniform failure code encompassing all possible variations of failure of a payment transaction due a lost/stolen credit card. As previously noted, some payment gateways may use multiple failure codes to represent variations of the same general reason for failure. For example, a payment gateway may use multiple failure codes for different variations of a lost/stolen card scenario, in which case, the normalization engine 220 may map all failure codes used by a given payment gateway to represent variations of the same general basis for failure to a single uniform failure code.

In some embodiments, any given payment response code returned by a payment gateway 204 may be represented as a vector of values in which each value represents the probability that the response code goes to another response code if the payment is retried. In some embodiments, each response code returned by a payment gateway 204 is first converted to such a vector prior to the normalization engine 220 normalizing the code to a uniform code. In other embodiments, the normalization process itself involves conversion of the various response codes returned by the payment gateways 204 to vectors of probabilities representing the likelihood that a response code changes to a different response code upon payment retry. That is, in some embodiments, the set of uniform codes may be a set of vectors, where each vector includes a set of values, and where each such value represents the probability of the uniform code changing to another uniform code upon payment retry.

In some embodiments, the payment response code normalization engine 220 may first normalize the payment response codes for historical payment transactions, and then the normalized payment response codes may be incorporated into the ground-truth payment outcome data 222 that is fed to the payment retry optimization machine learning engine 218. In this manner, the payment retry optimization machine learning engine 218 may train the payment retry optimization machine learning model more efficiently because the uniform failure codes allow for consistent interpretation of the reasons for failure of failed payment transactions.

In some embodiments, a payment application 206 executing on the server system 212 may be configured to initiate payment transactions. For instance, the payment application 206 may contact a payment gateway 204 to initiate a payment transaction and may receive a response code from the payment gateway 204 indicating a result of the transaction (e.g., a success code or a failure code). In some embodiments, the payment application 206 may contact a payment processor system (not shown), which in turn, may contact (or itself operate) the payment gateway 204. Upon receipt of the transaction details, the payment gateway 204 may send the information to a financial institution system (not shown), which may verify the account holder's identity and whether the payment method has sufficient funds/available credit to cover the payment amount. The financial institution system may then inform the payment gateway 204/payment processor whether the transaction has been authorized. In those embodiments in which the transaction is authorized, the payment processor system processes the transaction, and the payment gateway 204 returns a payment response code to the payment application 206 that indicates that the payment was successfully processed. On the other hand, in those embodiments in which the financial institution system does not authorize the transaction, the payment processor system refrains from processing the transaction, and the payment gateway 204 returns a failure response code indicating a reason for failure of the payment.

As noted, failed payment transactions may be retried one or more times. In some cases, the CPR module 208 may execute predefined failed payment retry timing strategies specified by a tenant. As noted, these predefined retry strategies may be tailored to particular subscriber groups and/or to particular failure type categories. Alternatively, according to embodiments of the disclosed technology, a trained payment retry optimization machine learning model may receive an overall payment retry window and a maximum permissible number of retry attempts as input and may output a set of optimal payment retry times for a given set of payment attributes of failed payment transaction. In particular, historical payment transaction attribute information including, among other attributes, normalized versions of the payment response codes returned by the payment gateways 204 for historical payment transactions, may be fed—as part of the ground-truth payment outcome data—to the payment retry optimization machine learning engine 220. The engine 220 may then train a payment retry optimization machine learning model to output optimal payment retry times for future failed payment transactions. In particular, the trained machine learning model may be utilized on tenant test data comprising failed payment transaction information to determine optimal times to retry the failed payments, given certain specified parameters such as an overall payment retry window and a maximum number of allowed retry attempts.

The payment retries may be initiated in a similar manner as the initial payment transactions, except that the CPR module 208, or more particularly, the payment retry optimization machine learning engine 218 may send commands to the payment application 206 to initiate payment retries in accordance with learned payment retry timing schedules. The payment gateways 204 may return payment response codes indicating success or failure of the payment retries. If a payment retry fails, the failure response code returned may indicate a reason for the failure, which could be different from the reason the initial payment transaction failed.

In some embodiments, the payment response codes and associated payment attribute information relating to retries of failed payment transactions (whether successful or not) can be provided as training feedback 210 to the payment retry optimization machine learning engine 218. The engine 218 may re-train the payment retry optimization machine learning model based on the training feedback 210 to refine/enhance the capability of the model to determine optimal failed payment retry timing. More specifically, as the trained model ingests additional information regarding the success/failure of payment retries, the trained model may become more adept at detecting subscriber groups and/or tailoring failed payment retry timing strategies to individual account holders.

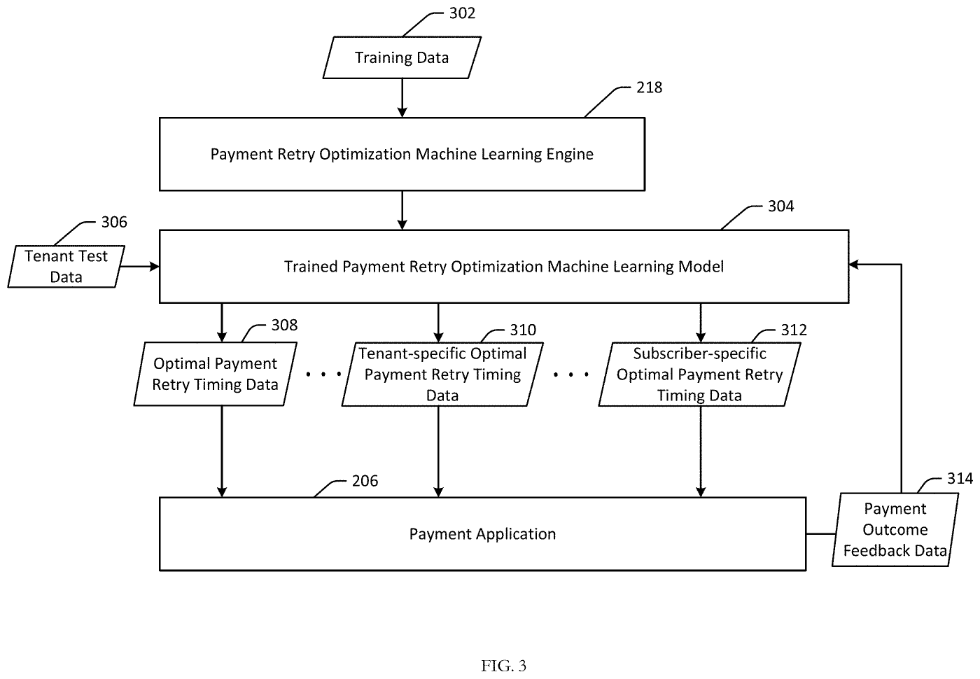

FIG. 3 depicts schematically depicts the process of training a payment retry optimization machine learning model and then refining the trained model using training feedback data in accordance with example embodiments of the disclosed technology. As depicted in FIG. 3, the payment retry optimization machine learning engine 218 may receive training data 302 as input. The training data 302 may include the ground-truth payment outcome data 224. The payment retry optimization machine learning engine 218 may then train a machine learning model (e.g., a failed payment retry optimization algorithm) based on the training data 302 to obtain a trained machine learning model 304 capable of identifying an optimal timing schedule for retrying failed payment transactions.

The trained model 304 may be applied to tenant test data 306, which may include payment attribute information, normalized failure codes, subscriber segment data 226, and the like for one or more failed payment transactions. The trained model 304 may be configured to determine optimal payment retry timing data 308 including optimal times at which one or more failed payment transactions represented in the tenant test data 306 should be retried. The payment application 206 may initiate the payment retries according to the times specified in the timing data 308 and based on tenant-specified parameters such as the overall retry period over which payment retries can be attempted for a given failed transaction and the maximum number of permissible retries. Payment outcome feedback data 314 indicative of payment outcomes (e.g., returned payment response codes) for the payment retries may then be provided as training feedback to the trained machine learning model 304 to enhance the predictive capabilities of the model. As the trained model 304 ingests additional payment outcome feedback data 314 for subscribers of a given tenant, the trained model 304 becomes more refined and capable of identifying tenant-specific optimal payment retry timing data 310 that indicates optimal retry times that are specifically tailored to subscribers of a particular tenant (e.g., particular subscriber groups of an individual tenant). Further, as the trained model 304 continues to ingest payment outcome feedback data 314, including payment outcome data for a particular subscriber of a particular tenant, the model 304 becomes capable of determining subscriber-specific optimal payment retry timing data 312 indicative of payment retry times deemed most optimal for the historical payment outcomes observed for an individual subscriber.

As previously noted, the training data 302 may include the payment outcome data 222 corresponding to historical payment transactions. As noted, the payment outcome data 222 includes payment attribute information such as payment response codes returned by payment gateways. In some embodiments, the training data 302 may also include data/information captured from one or more other sources. For instance, the training data 302 may include information gleaned from manual collection efforts. More specifically, in some embodiments, the training data 302 may include information gleaned directly from a subscriber (e.g., a collection call during which the subscriber provides information regarding dates that he receives paychecks each month), information gleaned from third-party data sources (e.g., information obtained from a credit reporting agency), and so forth.

FIG. 4A schematically depicts a specific implementation of a payment retry optimization strategy for optimizing the timing of payment retry windows in accordance with example embodiments of the disclosed technology, and FIG. 4B depicts how changing the overall payment retry period would impact the payment retry optimization strategy of FIG. 4A. It should be appreciated that FIGS. 4A and 4B depict an example implementation of a machine learning-based payment retry optimization strategy in accordance with embodiments of the disclosed technology. Other payment retry optimization strategies are contemplated as well. In particular, the payment retry optimization strategy/timing schedule depicted in FIGS. 4A and 4B may represent an output of the trained machine learning model 304 after the model 304 has ingested a certain amount of training data 302 (e.g., payment outcome data 222). As the trained model 304 ingests additional training data 302, the model 304 may refine/enhance/modify the example payment retry optimization strategy schematically depicted in FIGS. 4A and 4B.

The example payment retry optimization strategy implementation schematically represented in FIG. 4A assumes that the trained payment retry optimization model has determined various optimal timing characteristics that improve the likelihood of success of payment retries. These optimal timing characteristics may be applicable to subscriber groups including subscribers across multiple tenants, to subscriber groups containing subscribers of a particular tenant, and/or to individual subscribers. The optimal timing characteristics may include, for example, spacing retries apart to allow at least a threshold amount of waiting time between retries. This timing characteristic may be the result of the trained model determining that retrying minutes or a few hours after a failed retry attempt has a low probability of success.

Another example timing characteristic may be waiting at least a threshold period of time after the initial failed payment transaction to attempt the first retry. This timing characteristic may be the result of the trained model determining that a first retry attempted too quickly after the initial payment transaction fails has a low probability of success. In some embodiments, the initial waiting period for the first payment retry after the initial payment transaction fails may be longer in duration that the waiting periods between subsequent payment retries.

Yet another example timing characteristic may be attempting a payment retry that provides the longest waiting period possible between the initial failed payment transaction and the payment retry. This timing characteristic may be the result of the trained model determining that longer waiting periods for payment retries are positively correlated with increased probabilities of success of the retries. This example timing characteristic may be implemented by scheduling a payment retry as late as possible within a specified overall payment retry window.

Referring now to FIG. 4A, in example embodiments, prior to scheduling the payment retry windows, a tenant may be asked to specify, via one or more user interfaces of the CPR module 208, retry parameters including a maximum number of days after the initial failed transaction (i.e., payment attempt 0) over which to attempt retries of the payment (i.e., the overall payment retry period 402). The tenant may be further asked to specify a number of retry attempts between the first failure (payment attempt 0) and the last day of the overall payment retry period 402. To prevent a tenant from specifying a number of attempts that would violate the timing characteristics noted above (e.g., waiting a threshold period of time after payment attempt 0, waiting a threshold period of time between consecutive payment retries, etc.), a maximum number of possible retry attempts may be enforced for an overall payment retry period of a given length. The example of FIG. 4A assumes that the tenant has specified the maximum number of permissible retry attempts for the overall payment retry period 402 and that the overall payment retry period 402 is a duration of 7 days.

A sequence of blocks is depicted in FIG. 4A. Each block is a time segment 404 representing a 24 hour calendar day. An initial failed transaction (payment attempt 0) is illustratively depicted as occurring at some point during the 24 hour period represented by the first block in the sequence. The overall payment retry period 402 is a 7 day period beginning at failed payment attempt 0. It should be appreciated that the time segment 404 can be a shorter or a longer duration than 24 hours, the initial failed payment can occur at any time within a time segment 404, and the overall payment retry period 402 may be a shorter or a longer duration than the example 7 day period referenced with respect to FIG. 4A.

In an example embodiment, a first payment retry window that is scheduled may actually be a final payment retry window 406. The final payment retry window 406 may have a 24 hour duration and may end at the end of the overall payment retry period 402. It should be appreciated that although the payment retry windows described in this example implementation are each 24 hours in length, the retry windows may be of any suitable duration and different retry windows may have different lengths. Scheduling the final payment retry window 406 first is consistent with the timing characteristic noted above that payment retry windows that occur as far as possible from the initial failed payment (payment attempt 0) have the greatest likelihood of success.

If the tenant has selected only one retry attempt, the process is complete and the retry timing schedule is determined. On the other hand, if the tenant has indicated that two or more retry attempts should be made, the next payment retry window is scheduled an initial payment retry waiting period 410 after the initial failure. The next payment retry window scheduled at this stage is, in fact, the first payment retry window 408. That is, the first retry of failed payment attempt 0 occurs at some point within the first payment retry window 408. In some embodiments, in addition to learning the optimal scheduling of the payment retry windows, the trained payment retry optimization machine learning model also learns the most optimal time within those retry windows to initiate the payment retries. In some embodiments, the payment retries may be initiated at the same or at different times for different payment retry windows. An example technique for determining the optimal time for a payment retry within a payment retry window will be described in more detail later in this disclosure.

In some embodiments, the initial payment retry waiting period may be a longer duration than waiting periods between successive payment retry windows. For example, the initial payment retry waiting period 410 may be 48 hours in duration, while the waiting periods between successive payment retry windows may be 24 hours in duration. In some embodiments, the waiting periods between different pairs in consecutive payment retry windows may have different durations.

Referring now to FIG. 4B and continuing the discussion of the example payment retry timing strategy implementation of FIG. 4A, additional payment retry windows are scheduled starting from the final payment retry window 406, while ensuring that at least a threshold waiting period is provided between successive payment retry windows. In this example implementation, the waiting period between successive payment retry windows is 24 hours. Thus, as shown in the sequence of time segment blocks at the top of FIG. 4B, an additional payment retry windows 418 is scheduled within the overall payment retry period 402 starting from an end of the overall payment retry period 412 and working backwards. This approach may be taken to maximize an amount of time that elapses between the initial payment failure (payment attempt 0) and the retries of that failed payment. Further, as noted, a waiting period is provided between successive payment retry windows. More specifically, payment retry window 418 is scheduled prior to the final payment retry window 406 with the waiting period 416 provided between the payment retry window 418 and the final payment retry window 406. Moreover, payment retry window 418 is scheduled such that a waiting period 414 of sufficient duration (e.g., 24 hours) exists between the payment retry window 418 and the first payment retry window 408.

At this point in this example implementation, three payment retry windows have been identified for an example 7-day overall payment retry period based on the following example payment retry rules: 1) after a payment fails, schedule a 48-hour waiting period during which no retries can be attempted, 2) schedule a last payment retry window during the last 24 hours of the overall payment retry period, 3) schedule the first 24-hour payment retry window following the initial 48-hour waiting period, and 4) schedule any additional payment retry window(s) equidistantly with a 24-hour waiting period between successive payment retry windows, while ensuring that the other timing characteristic requirements are met. In some embodiments, after the payment retry windows have been determined, the actual time that the payment is retried within each payment retry window is determined.

In some embodiments, selecting optimal times for failed payment retries within payment retry windows may proceed according to the following algorithm: 1) select a payment retry window (e.g., a 24 hour period in this example implementation), 2) calculate 15 minute intervals with the select 24 hour payment retry window, 3) generate a candidate payment retry corresponding to each 15 minute interval, where each candidate payment retry is generated by holding all payment attributes constant except for the timing attribute, which is incremented by 15 minutes for each candidate payment retry, 4) provide the candidate payment retries to the trained payment retry optimization machine learning model 304 to obtain a ranking of respective scores assigned to the candidate payment retries, where each score represents a probability that the corresponding candidate payment retry is successful 5) schedule the payment retry at the time corresponding to the highest scored candidate payment retry, and 6) repeat for each other payment retry window. It should be appreciated that just as the duration of the payment retry windows may vary in different embodiments, so too can the duration of the timing intervals that form the basis for generating candidate payment retries within a payment retry window.

Consider, for example, a payment transaction with the following payment attributes. Assume that this payment transaction has not yet been attempted for a first time, but will fail when attempted. As such, the retry number and time since last payment fields are empty. The abbreviation “Curr.” is used to denote the “currency” attribute.

| Payment | Payment | | Time since | Payment | Payment | CC | Retry | |
|---|---|---|---|---|---|---|---|---|
| Date | Gateway | Curr. | last Payment | Country | Value | Type | # | MRR |
| 2021 Oct 6 | Paypal | USD | | USA | 10.00 | Visa | | 20.00 |
| 10:00:00 | | | | | | | | |

Now presume that the above payment transaction has failed and payment retry windows have been identified according to the techniques disclosed above, for example. To generate candidate payment retries corresponding to the failed transaction, candidate times may first be determined by breaking a 24 hour payment retry window in 15 minute increments. Candidate payment retries may then be generated by holding all over payment attributes of the original payment constant and varying only the timing-related field, with each candidate time being selected to generate a respective corresponding candidate payment retry. The following table illustrates an example subset of the candidate retries that may be generated for the first payment retry after the initial payment fails and the 48 hour waiting period elapses. This table illustrates how non-timing aspects of a failed payment may be held constant, while only the timing aspects are changed for candidate retries.

| Payment | Payment | | Time since | Payment | Payment | CC | Retry | |
|---|---|---|---|---|---|---|---|---|
| Date | Gateway | Curr. | last Payment | Country | Value | Type | # | MRR |
| 2021 Oct. 8 | Paypal | USD | 48 | USA | 10.00 | Visa | 1 | 20.00 |
| 10:00:00 | | | | | | | | |
| 2021 Oct. 8 | Paypal | USD | 48 | USA | 10.00 | Visa | 1 | 20.00 |
| 10:15:00 | | | | | | | | |
| 2021 Oct. 08 | Paypal | USD | 48 | USA | 10.00 | Visa | 1 | 20.00 |
| 10:30:00 | | | | | | | | |

After all candidate payment retries have been generated for a payment retry window (e.g., a 24 hour window), the trained payment retry optimization model 304 may score the retries based on their likelihood of success. In particular, the trained model 304 may assign a score to each candidate payment retry that indicates a probability of success of the retry. More specifically, the trained model 304 may evaluate the various payment attributes of the candidate retries (including the timing of the candidate retry and the non-changed attributes from the original failed transaction) as well as tenant/subscriber group data to determine the likelihood that the candidate payment retry succeeds and may generate and assign a score to the retry that is representative of this likelihood of success. The candidate payment retries may then be ranked according to their likelihood of success scores, and the highest ranked candidate payment retry (i.e., the one that the trained model 304 determines has the greatest probability of success) may be chosen for the selected payment retry window. That is, the payment retry for the selected payment retry window may be scheduled at the time corresponding to the candidate payment retry that is ranked highest. For instance, given the three example candidate payment retries in the table above, if the second candidate payment retry is ranked highest, then the first payment retry for the failed payment transaction would be scheduled for 2021-10-08 at 10:15:00.

As previously noted, an example implementation of a payment retry optimization strategy may require an initial waiting period 410 after the initial failed payment (payment attempt 0) prior to scheduling a payment retry window. Further, in some embodiments, the initial payment retry waiting period 410 is a longer duration than the waiting period 414 between consecutive payment retry windows. As previously described, for a duration of 7 days for the overall payment retry period 402, it is possible to schedule three payment retry windows (each of 24 hours duration) within the overall payment retry period 402, while still ensuring that the timing characteristic requirements in this example are met (an initial waiting period 410 of 48 hours and a waiting period 414 between successive payment retry windows of 24 hours).

In this example implementation, if a tenant attempts to specify a greater number of retries than three, the CPR module 208 would generate an error prompting the tenant to increase the length of the overall payment retry period 402. In particular, there is no available space within the specified overall payment retry period 402 to accommodate an additional payment retry window while still adhering to the timing characteristic requirements of this example (an initial waiting period 410 of 48 hours and a waiting period 414 between successive payment retry windows of 24 hours). As shown at the top of FIG. 4B, an overall payment retry period 402 of 7 days permits the payment retry windows to be scheduled symmetrically within the example timing characteristic constraints noted above without leaving any extra time between the first failed payment and the first payment retry window 408 beyond that required for the initial payment retry waiting period 410 (48 hours) and without leaving any extra time between successive payment retry windows beyond that required for the waiting period 414 (24 hours).

In contrast, the sequence of time segments at the bottom of FIG. 4B demonstrates what can occur if the overall payment retry period 402 is changed. In this example, the overall payment retry period 402 is extended to 10 days. Each block continues to represent a time segment 404 of 24 hour duration. Further, each payment retry window is 24 hours in duration, a waiting period 428 between successive payment retry windows is 24 hours, and the duration of an initial payment retry waiting period 424 is 48 hours. In accordance with the same methodology described above, a final payment retry window 422 is scheduled from an end of the overall payment retry period 420 in order to ensure a payment retry occurs as far as possible from the initial failed payment transaction. Then, a first payment retry window 426 is scheduled after the initial waiting period 424. Following that, the payment retry window 430 is scheduled prior to the final payment retry window 422, but with the waiting period 428 provided there between. An additional payment retry window 432 is then scheduled prior to the payment retry window 430, with another waiting period 428 provided there between.

At this point, the payment retry windows 422, 426, 430, and 432 have all been scheduled. In this example, another payment retry window cannot be scheduled without violating the timing characteristic constraints of a 48 hour initial waiting period 424 and a 24 hour waiting period 428 between payment retry windows. In particular, scheduling another payment retry window between the payment retry windows 426 and 432 would leave less than a 24 hour waiting period between the newly scheduled payment retry window and either payment retry window 426 or payment retry window 432. As such, a waiting period 434 of a longer duration occurs between the payment retry window 426 and the payment retry window 432 than a required duration of the waiting period 428 between successive payment retry windows. Thus, FIG. 4B demonstrates how the duration of the overall payment retry period 402 can impact the maximum permissible number of payment retry windows that can be scheduled the overall payment retry period 402 while still ensuring that timing characteristic constraints such as a minimum required waiting time after initial failed payment and a minimum required waiting time between successive payment retry windows are met.

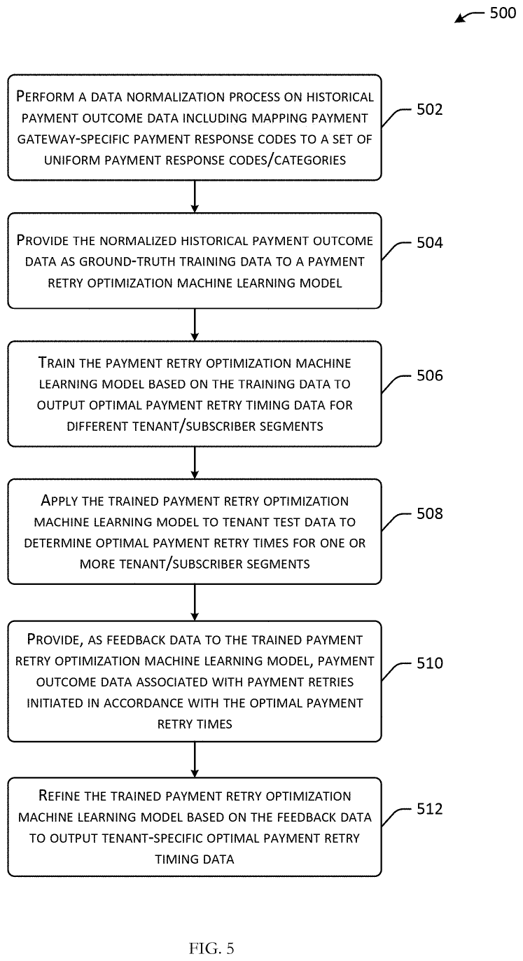

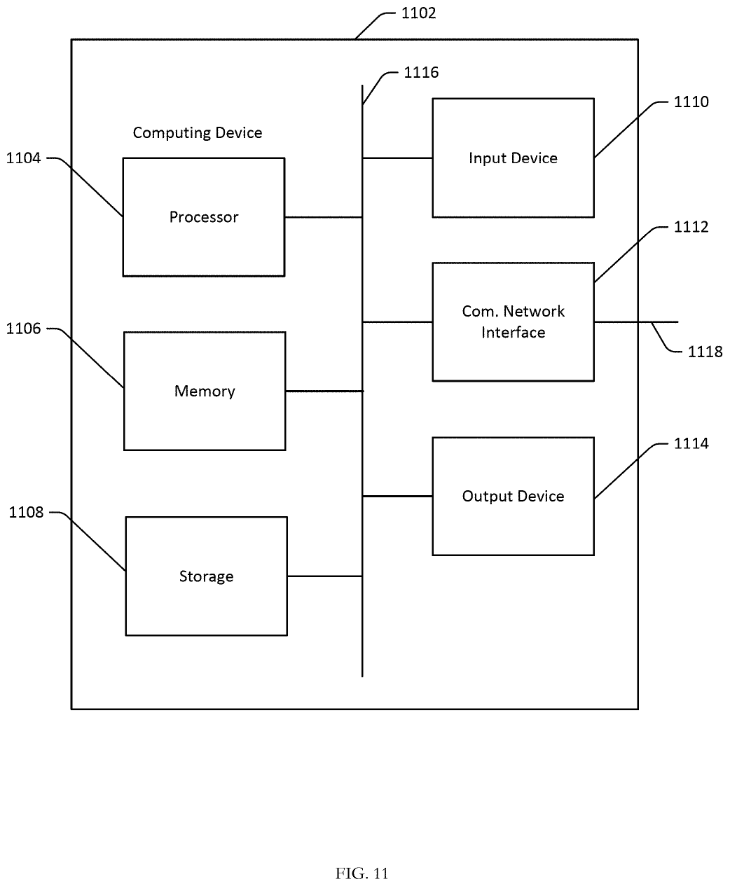

FIG. 5 depicts a flowchart representing an illustrative method 500 for training a payment retry optimization machine learning model and utilizing the trained model to determine optimal payment retry times for one or more tenant/subscriber segments. In some embodiments, the method 500 may be performed responsive to execution, by one or more computer processors (e.g., any of the types of processors described later in this disclosure in reference to the processor 1104 depicted in FIG. 11) of machine-executable instructions contained in one or more modules/engines executing on the server system 212 such as the CPR module 208, the payment retry optimization machine learning engine 218, and/or the payment response code normalization engine 220. It shall be understood that reference herein to a particular module/engine performing one or more operations implies that the one or more operations are performed responsive to machine-executable instructions of the module/engine being executed by one or more processors. The illustrative method 500 of FIG. 5 may be described at times hereinafter with reference to FIGS. 2 and 3.

At block 502, the payment response code normalization engine 220 may perform a data normalization process on historical payment outcome data. The data normalization process may include normalizing payment response codes returned by the payment gateways 204 for historical payment transactions. The payment response codes may include a respective set of payment response codes specific to each payment gateway 204. Normalizing the gateway-specific payment response codes may include mapping the gateway-specific payment response codes to a set of uniform payment response codes, where each uniform code represents, for example, a failure type category that encompasses a multitude of gateway-specific codes associated with the same general reason for failure of a payment transaction. In some embodiments, each uniform payment response code may be a vector of values, where each value represents the probability of the uniform code changing to another uniform code upon payment retry.

At block 504, the normalized historical payment outcome data including the uniform payment response codes to which the response codes returned by the various payment gateways 204 for historical payment transactions are mapped may be provided to the payment retry optimization machine learning engine 218 as part of the ground-truth payment outcome data 222. More specifically, the engine 218 may feed the ground-truth payment outcome data 222 as the training data 302 to the payment retry optimization machine learning model 304.

At block 506, the engine 218 may train the payment retry optimization machine learning model 304 based on the training data 302 to output optimal payment retry timing data (e.g., timing data 308, 310, and/or 312) for one or more subscriber segments. In some embodiments, the machine learning model 304 may be configured to learn the one or more subscriber segments during training as the model 304 determines, for example, that a different set of optimal payment retry times is more likely to result in ultimate success of the failed payment for a given group of one or more subscribers than a set of payment retry times determined to be optimal for another group of one or more subscribers. As the trained model 304 identifies subscriber segments, segment data 224 indicative of the subscriber segments can be stored in the datastore(s) 214. Further, as previously noted, a tenant may also be provided with the capability to define its own subscriber groups.

At block 508, the trained machine learning model 304 may be applied to tenant test data 306 to determine optimal failed payment retry times for failed payment transactions represented in the test data 306. In some embodiments, the trained model 304 may determine a respective set of optimal payment retry times to be applied to failed payment transactions in each subscriber group. For instance, the trained model 304 may apply a first set of optimal payment retry times to a first subscriber group (e.g., for failed payment transactions involving subscribers located in North America) and a second set of optimal payment retry times for a second subscriber group (e.g., for failed payment transactions involving subscribers located in Europe).

In some embodiments, payment response codes that are categorized in a “hard decline” category may be treated differently with respect to retries than other payment response codes. For instance, given that “hard declines” generally have a very low likelihood of success upon retry, in some embodiments, the trained model 304 may retry a “hard decline” failed payment transaction only once. A single retry of a “hard decline” may be initiated if, for example, the model 304 determines that all gateway codes—regardless of their categorization—have some chance of success, even if miniscule.

At block 510, payment outcome data 314 associated with the failed payment retries initiated in accordance with the optimal retry times identified by the trained model 304 may be provided as feedback data back to the model 304. Then, at block 512, the model 304 may be re-trained based on the feedback data 312 to refine the model's 304 ability to ascertain new subscriber groups and corresponding optimal payment retry times. More specifically, as additional payment outcome data 314 relating to retries of failed payments is ingested by the model 304 as feedback data, the model 304 becomes more capable of identifying optimal payment retry times that are specific to subscribers of a particular tenant, and ultimately, optimal retry times that are specifically tailored to individual subscribers.

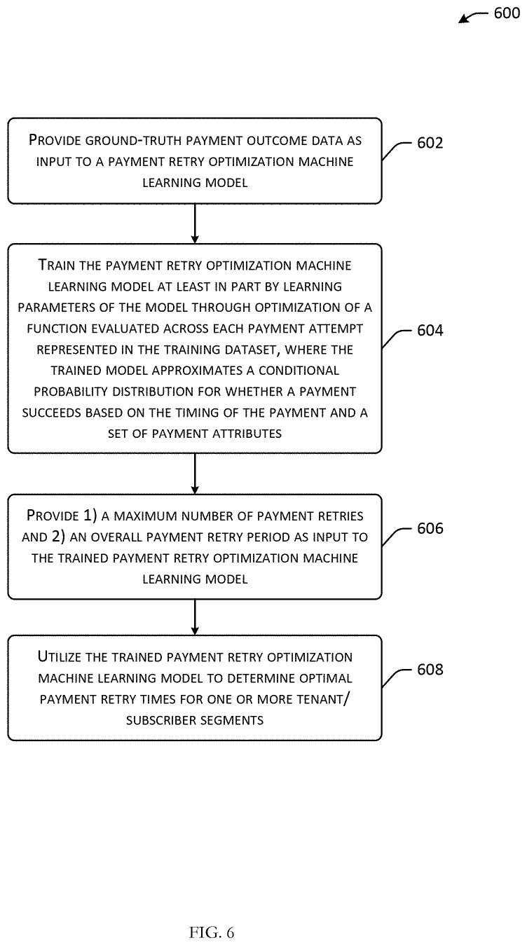

FIG. 6 depicts a flowchart representing a specific implementation of the illustrative method depicted in the flowchart of FIG. 5 in accordance with example embodiments of the disclosed technology. At block 602, the ground-truth payment outcome data 222 may be provided to the payment retry optimization machine learning model 304. More specifically, the ground-truth payment outcome data 222 may be provided to the payment retry optimization machine learning engine 218, which in turn, may feed the input data to the machine learning model 304. The payment outcome data 222 may include data indicative of attributes of historical payment transactions. The payment attributes may include any of those previously described, or more generally, any aspect/characteristic of a payment transaction which may have an impact on the likelihood of success of a retry if the transaction fails.

At block 604, the payment retry optimization machine learning engine 218 may train the machine learning model 304 based on the input payment outcome data 222. In some embodiments, the machine learning model 304 may be a machine learning algorithm that approximates the conditional probability distribution p(s|t, x) with p_{θ}(s|t, x), where s is whether or not a payment succeeds, t is the time of the payment, x is a vector of payment attributes, and θ represents the parameters of a gradient-boosted tree model. In some embodiments, these parameters are learned by optimizing the following function: θ_{model}=argmin_{θ∈θ} Σ_{i∈I} [ln(1+e^{-p}^{_{θ}}^{(s|t}^{ᵢ}^{x}^{ᵢ}⁾) sᵢ+ln(1+e^{P}^{_{θ}}^{(s|t}^{ᵢ}^{x}^{ᵢ}⁾)(1−sᵢ) where each i∈I represents a sample attempt at collecting on an invoice from the training dataset (i.e., the payment outcome data 222).

Then, at block 606, various input parameters may be provided to the trained machine learning model 304 (e.g., the machine learning algorithm that approximates the conditional probability distribution described above). These input parameters may include an overall payment retry period over which retries of a failed payment transaction can be initiated and a maximum number of permissible retries that can be attempted over the course of the overall payment retry period. A tenant may provide these input parameters via one or more user interfaces of the CPR module 208, for example. At block 608, the trained machine learning model 304 may be used to determine optimal payment retry times for failed payment transactions given the input constraints provided to the model at block 606. In some embodiments, once the trained model 304 is obtained (e.g., the approximation p_{θ} of the conditional probability distribution p(s|t, x)), then a final optimization is done: tₒₚₜᵢₘₐₗ=argmax_{t≥t}_{_{current}} p_{θ}(s|t, x) This final optimization outputs an optimal retry time for a given failed payment transaction.

In some embodiments, an A/B test may be used to validated performance of the trained payment retry optimization model. An A/B test may include a randomized controlled experiment in which two version of a variable are compared to determine which of the two variants is more effective. An A/B test may compare two versions of a variable where only one aspect of the variable has changed. Thus, an A/B test can be used to compare different payment transactions where only the timing attribute has changed. A randomized controlled trial (RCT) is a type of experiment that is used to help determine the impact of an experiment on a population. In an RCT, the eligible population is split into two groups chosen at random. One group is the “control group” and nothing is changed about this group. The other group is the “experimental group” and this is the group that receives the treatment in the experiment, meaning the variable that the experiment is trying to measure. The important feature of an RCT is that each member of the eligible population is randomly assigned to either the control or experimental group.

In some embodiments, the control group may include failed payments that followed a customer-defined retry logic such as via the CPR module 208. The experimental group may include failed payments that were scheduled at optimal times determined by the trained payment retry optimization machine learning model 304, within the customer-specified constraints of an overall payment retry period and a maximum number of permissible retries. In some embodiments, failed payments may be randomly assigned to one of the two groups according to the last digit of an account's universally unique identifier (UUID). The metric evaluated by the RCT may be a document success rate (DSR), where a document is defined as an invoice or a debit memo that has been fully completed and is not in flight in a retry cycle. DSR may be defined as follows: DSR=S/T, where S is the number of successful completed documents collected and T is the total number of completed documents attempted. This metric may be tied to customer churn and customer lifetime value (CLV) and may be invariant to a number of times a failed payment is retried as shown in the following relationship: CLV=(mRR/churn)—CAC, where mRR is monthly recurring revenue and CAC is customer acquisition costs. The churn rate is made up of both involuntary churn and voluntary churn for customers. Involuntary churn may be caused by failed payments followed by a customer's subscription being cancelled. Thus, in some embodiments, reducing the probability of involuntary churn leads to a smaller probability of overall churn, which in turn, results in a smaller denominator in the calculation of CLV. Increasing the DSR metric can thus reduce churn. Running the experiment on the above-mentioned control and experimental groups may reveal that payment retries that occur at times determined by a trained payment retry optimization machine learning model in accordance with embodiments of the disclosed technology results in a statistically significant increase in the DSR.

It should be noted that although the terms “optimize,” “optimal” and the like may be interpreted as referring to the best possible performance/selection/outcome, those terms, as used herein, refer to achieving a performance/selection/outcome that represents an improvement over prior known alternatives, within one or more constraints. For instance, determining an optimal timing schedule for failed payment retries may involve determining an improved timing schedule over prior known timing schedules given the constraints of an existing retry ruleset, currently available payment outcome data, and the like. For instance, in the context of a retry of a failed payment transaction, an optimal timing for initiating the retry may be a time at which there is an improved likelihood that the payment retry is successful as compared to one or more other available times. In another non-limiting example, an optimal timing for initiating a retry of a failed payment may be a time at which there is an improved likelihood that the payment code returned by the payment gateway for the retry changes to a failure code that has a higher likelihood of ultimately resulting in a successful outcome for the failed payment. It should be appreciated that as the payment retry optimization machine learning model ingests additional payment outcome data, new optimized payment retry timing schedule may be generated if they represent an improvement over prior timing schedules, which were based on a lesser amount of payment outcome data. In some embodiments, such as during initial stages of training the machine learning model, there may not be enough payment outcome data to ascertain an optimized (e.g., improved) payment retry timing schedule, in which case, a default timing schedule or a random timing schedule may initially be selected for failed payment retries until the machine learning model ingests enough payment outcome data to begin optimizing the timing schedules for particular subscriber groups.

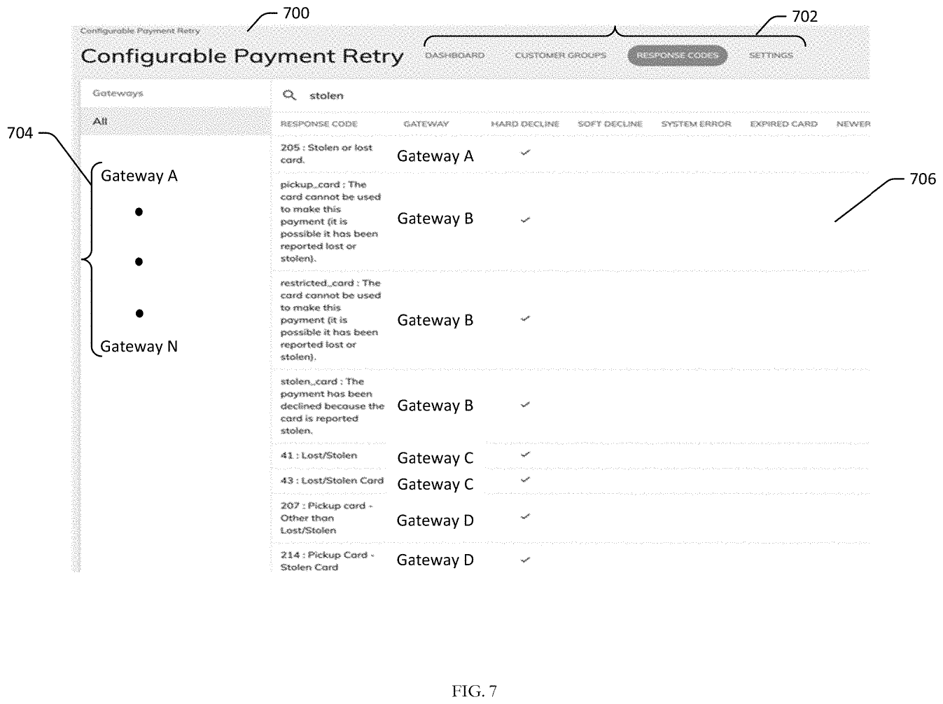

FIG. 7 depicts an example user interface (UI) 700 for accessing configurable payment retry (CPR) functionality in accordance with example embodiments of the disclosed technology. The UI 700 includes a set of selectable widgets 702 for accessing different parts of the CPR functionality. In this example, a widget for accessing various payment gateway response codes has been selected. A listing 704 of payment gateways is shown to the left of the UI 700. The payment gateways identified in the listing 704 may include payment gateways 204.

The search term “stolen” is illustratively depicted as being entered into a search field in the UI 700. The CPR module 208 may be configured to search for all payment gateway response codes that match the entered search term. In this example, the CPR module 208 may search for all payment gateway response codes that relate to a stolen form of payment or otherwise include the term “stolen” in their code descriptions. The results 706 of the search are illustratively shown as being displayed in the UI 700. As shown, different payment gateways utilized different codes to represent the same general basis for failure of a payment transaction—a stolen card. Moreover, some payment gateways (e.g., gateway B) utilize multiple payment response codes to represent variations of the same “stolen card” scenario.

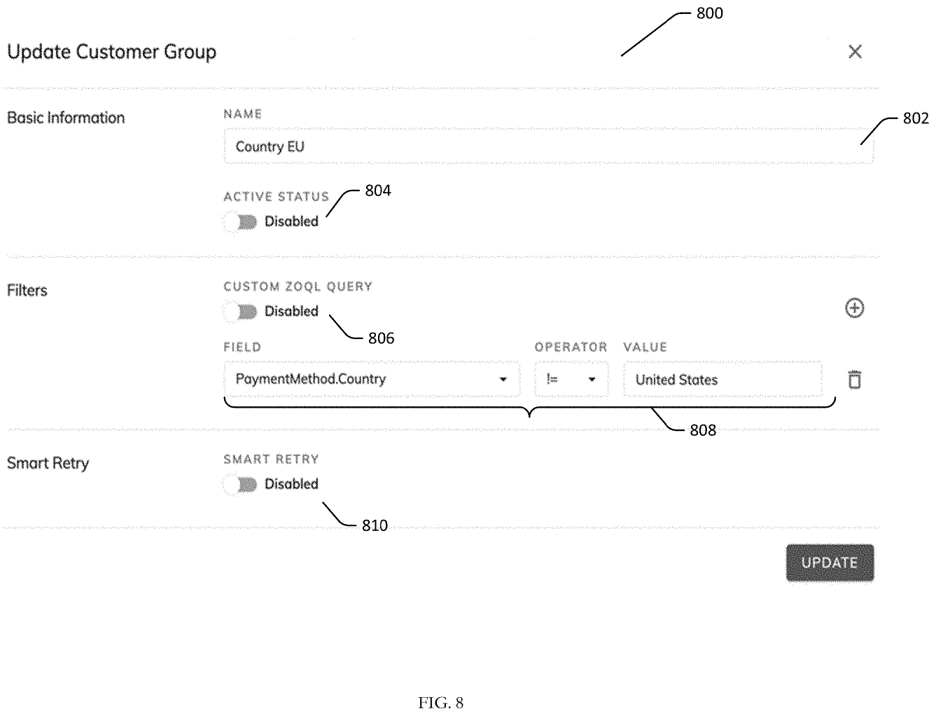

FIG. 8 depicts an example UI 800 for selecting/modifying settings for a subscriber group in accordance with example embodiments of the disclosed technology. In this example, the UI 800 is displaying information relating to a subscriber group that includes subscribers located in the European Union (EU). The subscribers in the EU subscriber group may belong to a single tenant or multiple tenants. The UI 800 includes a field 802 for specifying a name of the subscriber group. The UI 800 further includes a selectable widget 804 that can be toggled between an active status in which, for example, the trained machine learning model 304 applies optimal payment retry timing schedules for failed payments associated with members of the subscriber group, and an inactive/disabled status in which the subscriber group may not be considered as a separate entity when determining optimal payment retry timing.

The UI 800 may further include a selectable widget 806 that enables a tenant to toggle between an active status or a disabled status for custom-defined filters. More specifically, when the widget 806 is set to active, one or more custom-defined filters may be applied to filter payment transactions relating to members of the subscriber group from payment transactions that are not relevant to the subscriber group. An example filter 808 is shown in FIG. 8 in which any payment transaction in which the country associated with the payment method is not the United States would be associated with the EU subscriber group. The UI 800 also includes a selectable widget 810 via which the functionality of the trained machine learning model 304 can be activated or disabled. If the widget 810 is activated, the trained model 304 may be configured to output optimal payment retry times for failed payment transactions involving members of this subscriber group.

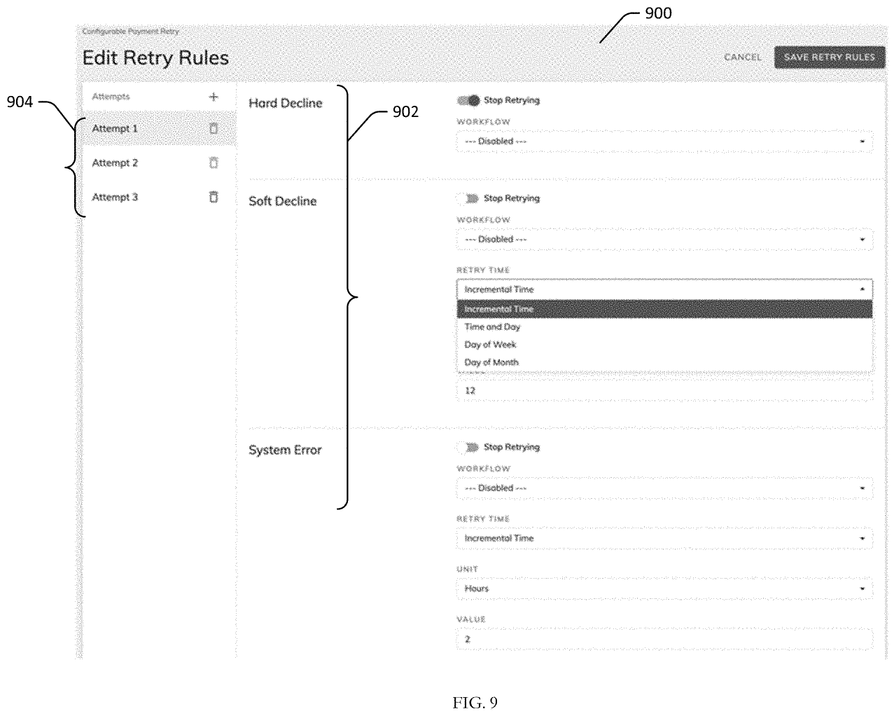

FIG. 9 depicts an example UI 900 for defining/editing payment retry rules in accordance with example embodiments of the disclosed technology. The UI 900 provides the capability for a tenant to define different retry rules/strategies for different failure type categories 902. As previously noted, payment response codes returned by payment gateways in connection with failed payment transactions may be categorized into different failure type categories 902 such as a “hard decline” category, a “soft decline” category, and a “system error” category. UI 900 provides a tenant with the capability to define rules for different payment retry attempts 904 of a failed payment transaction. The rules may specific to the failure type categories 902. For instance, a retry rule may indicate that no retries (or perhaps only a single retry) should be attempted for a “hard decline” transaction. This may be specified via activation of a “stop retrying” widget. For the failed payments categorized as a “soft decline” or a “system error,” the retry rules may specify a specific day/time for a payment retry or a periodic schedule for the retries. It should be appreciated that UI 900 may enable a manual scheduling capability of the CPR module 208 for payment retries. As described throughout herein, this capability is technologically enhanced by a “smart retry” capability provided by the trained machine learning model 304.

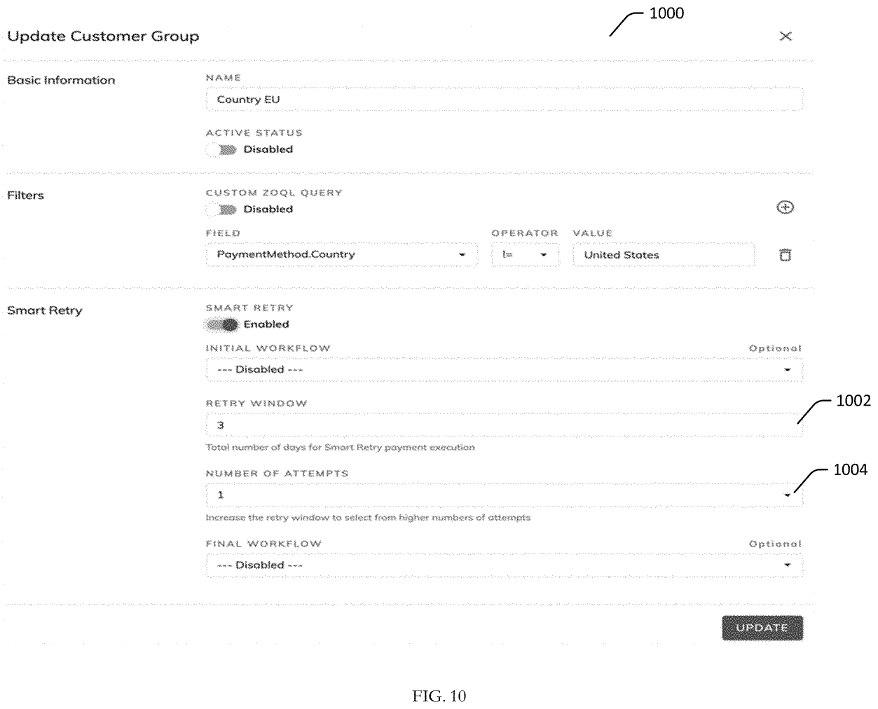

FIG. 10 depicts an example UI 1000 for configuring parameters for machine learning-based payment retry optimization in accordance with example embodiments of the disclosed technology. The UI 1000 corresponds to the UI 800, but with the “smart retry” widget 810 enabled. Once enabled, fields 1002 and 1004 are revealed. In field 1002, a tenant can specify a duration of an overall payment retry period. In field 1004, a tenant can specify a maximum number of retry attempts that can be made. In some embodiments, the UI 1000 would display an error message if a tenant attempts to select a number of attempts that exceeds the maximum permissible number of attempts allowed for the selected overall retry period. For instance, if a tenant attempts to select a number of retry attempts that would violate timing constraints for waiting periods after an initial failure, waiting periods between successive payment retry windows, or the like. In some embodiments, the UI 1000 would also provide the capability to configure one or more timing constraints. For instance, although not depicted in FIG. 10, the UI 1000 may include one or more additional fields whereby a tenant can select a duration of an initial waiting period after the first failed transaction before scheduling a first payment retry window; a duration of waiting periods between successive payment retry windows, a duration of a payment retry window, and/or when, within a given payment retry window, a payment retry is to be initiated.

FIG. 11 depicts a diagram of an example of a computing device 1102. Any of the systems, engines, datastores, and/or networks described herein may comprise one or more instances of the computing device 1102. In some example embodiments, functionality of the computing device 1102 is improved to the perform some or all of the functionality described herein. The computing device 1102 comprises a processor 1104, memory 1106, storage 1108, an input device 1110, a communication network interface 1112, and an output device 1114 communicatively coupled to a communication channel 1116. The processor 1104 is configured to execute executable instructions (e.g., programs). In some example embodiments, the processor 1104 comprises circuitry or any processor capable of processing the executable instructions.

The memory 1106 stores data. Some examples of memory 1106 include storage devices, such as RAM, ROM, RAM cache, virtual memory, etc. In various embodiments, working data is stored within the memory 1106. The data within the memory 1106 may be cleared or ultimately transferred to the storage 1108.

The storage 1108 includes any storage configured to retrieve and store data. Some examples of the storage 1108 include flash drives, hard drives, optical drives, cloud storage, and/or magnetic tape. Each of the memory system 1106 and the storage system 1108 comprises a computer-readable medium, which stores instructions or programs executable by processor 1104.

The input device 1110 is any device that inputs data (e.g., mouse and keyboard). The output device 1114 outputs data (e.g., a speaker or display). It will be appreciated that the storage 1108, input device 1110, and output device 1114 may be optional. For example, the routers/switchers may comprise the processor 1104 and memory 1106 as well as a device to receive and output data (e.g., the communication network interface 1112 and/or the output device 1114).

The communication network interface 1112 may be coupled to a network (e.g., network 108) via the link 1118. The communication network interface 1112 may support communication over an Ethernet connection, a serial connection, a parallel connection, and/or an ATA connection. The communication network interface 1112 may also support wireless communication (e.g., 802.11 a/b/g/n, WiMax, LTE, WiFi). It will be apparent that the communication network interface 1112 may support many wired and wireless standards.

It will be appreciated that the hardware elements of the computing device 1102 are not limited to those depicted in FIG. 11. A computing device 1102 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1104 and/or a co-processor located on a GPU (i.e., NVidia).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

What is claimed is:

1. A method for event timing optimization in a multi-tenant computing environment, the method comprising:
obtaining event outcome data indicating a failure type of each of a plurality of failed events;
using the event outcome data as training data to train an event retry optimization machine learning model;
using the trained event retry optimization machine learning model to determine a timing schedule for retrying a particular failed event of the plurality of failed events for a particular tenant in the multi-tenant computing environment, the timing schedule being based on event outcome trends observed for a subscriber segment associated with the particular failed event; and
retrying the particular failed event in accordance with the determined timing schedule.

2. The method of claim 1, wherein the plurality of events is a plurality of attempted payment transactions, the particular failed event is a particular attempted payment transaction corresponding to a particular subscriber belonging to the subscriber segment of the particular tenant, and the timing schedule is a payment retry timing schedule.

3. The method of claim 2, wherein the failure type includes a failure response code indicative of a reason for failure.

4. The method of claim 3, wherein obtaining the event outcome data comprises:
receiving a first failure response code associated with a first schema, the first failure response code corresponding to a first failed payment transaction of the plurality of attempted payment transactions;
receiving a second failure response code associated with a second schema different from the first schema, the second failure response code corresponding to a second failed payment transaction of the plurality of attempted payment transactions; and
generating the event outcome data at least in part by normalizing the first failure response code and the second failure response code to a uniform failure code format.

5. The method of claim 4, wherein normalizing the first failure response code and the second failure response code comprises:
determining that the first failure response code and the second failure response code identify respective reasons for failure that are categorized into a same failure category; and
mapping the first failure response code and the second failure response code to the uniform failure code format.

6. The method of claim 2, wherein retrying the failed payment transaction in accordance with the determined payment retry timing schedule comprises:
determining an overall payment retry period for retrying the failed payment transaction one or more times; and
scheduling a last retry of the failed payment transaction within a last payment retry window immediately preceding an end of the overall payment retry period.

7. The method of claim 6, wherein retrying the failed payment transaction one or more times in accordance with the determined payment retry timing schedule further comprises:
determining a time that the failed payment transaction initially failed;
determining that a maximum number of retries of the failed payment transaction has not been met;
determining that a duration of the overall payment retry period accommodates an initial payment retry window that begins after expiration of a first waiting period following the time that the failed payment transaction initially failed such that a time period between an end of the initial payment retry window and a beginning of a first payment retry window subsequent to the initial payment retry window is at least as long as a second waiting period; and
scheduling an initial retry of the failed payment transaction within the initial payment retry window.

8. The method of claim 7, wherein the first waiting period has a longer duration than the second waiting period.

9. The method of claim 7, wherein retrying the failed payment transaction in accordance with the determined payment retry timing schedule further comprises:
determining that the maximum number of retries of the failed payment transaction has not been met;
determining that the duration of the overall payment retry period accommodates an intermediate payment retry window that begins after expiration of the second waiting period following the initial payment retry window such that a time period between an end of the intermediate payment retry window and a beginning of a first payment retry window subsequent to the intermediate payment retry window is at least as long as the second waiting period; and
scheduling an intermediate retry of the failed payment transaction within the intermediate payment retry window.

10. The method of claim 7, wherein retrying the failed payment transaction in accordance with the determined payment retry timing schedule further comprises:
determining that the maximum number of retries of the failed payment transaction has not been met;
determining that the duration of the overall payment retry period cannot accommodate an intermediate payment retry window that begins after expiration of the second waiting period following the initial payment retry window because a period of time between an end of the intermediate payment retry window and a beginning of a first payment retry window subsequent to the intermediate payment retry window would be shorter in duration than the second waiting period; and
excluding the intermediate payment retry window from the determined payment retry timing schedule.

11. A system for optimizing timing of recurring payment retries of a failed payment transaction, the system comprising:
at least one memory storing computer-executable instructions; and
at least one processor configured to access the at least one memory and execute the computer-executable instructions to:
train a payment retry optimization machine learning model using historical payment outcome data as training data, the historical payment outcome data indicating a failure type of each of a plurality of failed payment transactions;
apply the trained payment retry optimization machine learning model to a particular failed payment transaction to obtain a set of one or more optimal payment retry times for a subscriber segment to which the particular failed payment transaction relates, the set of one or more optimal payment retry times for the subscriber segment being based on event outcome trends observed for the subscriber segment associated with the particular failed event; and
retry the particular failed payment transaction at the one or more optimal payment retry times.

12. The system of claim 11, wherein the at least one processor is further configured to execute the computer-executable instructions to:
obtain payment outcome data for retries of the particular failed payment transaction at the set of one or more optimal payment retry times; and
provide the payment outcome data as feedback training data to the trained payment retry optimization machine learning model to enhance the trained payment retry optimization machine learning model to output a new set of one or more optimal payment retry times.

13. The system of claim 12, wherein the particular failed payment transaction is a first failed payment transaction, and wherein the at least one processor is further configured to execute the computer-executable instructions to:
apply the enhanced payment retry optimization machine learning model to a second failed payment transaction relating to the subscriber segment to obtain a set of one or more tenant-specific optimal payment retry times that account for the payment outcome trends observed in the subscribers of the specific tenant who belong to the subscriber segment; and
retry the second failed payment transaction at the set of one or more tenant-specific optimal payment retry times.

14. The system of claim 13, wherein the payment outcome data is first payment outcome data, and wherein the at least one processor is further configured to execute the computer-executable instructions to:
obtain second payment outcome data for one or more retries of the second failed payment transaction at the set of one or more tenant-specific optimal payment retry times; and
provide the second payment outcome data as additional feedback training data to the enhanced payment retry optimization machine learning model to further enhance the payment retry optimization machine learning model to output a new set of optimal payment retry times.

15. The system of claim 11, wherein the at least one processor is further configured to execute the computer-executable instructions to:
perform a normalization of the historical payment outcome data; and
provide the normalized historical payment outcome data as training data to the payment retry optimization machine learning model.

16. The system of claim 15, wherein the at least one processor is configured to perform the normalization of the historical payment outcome data by executing the computer-executable instructions to:
determine that different payment response codes from different payment gateways are each indicative of a particular type of payment failure;
categorize the different payment response codes into a failed payment category associated with the particular type of payment failure; and
map the different payment response codes to a uniform failure code formal representative of the particular type of payment failure.

17. The system of claim 11, wherein the at least one processor is configured to train the payment retry optimization machine learning model using the historical payment outcome data as training data by executing the computer-executable instructions to:
learn parameters of the payment retry optimization machine learning model through optimization of a function evaluated across each payment attempt represented in the historical payment outcome data.

18. The system of claim 17, wherein the trained payment retry optimization machine learning model approximates a conditional probability distribution for whether an input payment transaction succeeds based on a timing of the input payment transaction and a set of vector attributes associated with the input payment transaction.

19. The system of claim 11, wherein the at least one processor is further configured to execute the computer-executable instructions to:
receive a maximum number of payment retries and an overall payment retry period as input constraints,
wherein the trained payment retry optimization machine learning model is configured to output the set of optimal payment retry times for the failed payment transaction based on the input constraints.

20. The system of claim 19, wherein the maximum number of payment retries and the overall payment retry period are user-configurable for the subscriber segment.

21. A computer program product for optimizing timing of recurring payment retries of a failed payment transaction, the computer program product comprising a non-transitory computer-readable medium readable by a processing circuit, the non-transitory computer-readable medium storing instructions executable by the processing circuit to cause a method to be performed, the method comprising:
train a payment retry optimization machine learning model using historical payment outcome data as training data, the historical payment outcome data indicating a failure type of each of a plurality of failed payment transactions;
apply the trained payment retry optimization machine learning model to a particular failed payment transaction to obtain a set of one or more optimal payment retry times for a subscriber segment to which the particular failed payment transaction relates, the set of one or more optimal payment retry times for the subscriber segment being based on event outcome trends observed for the subscriber segment associated with the particular failed event; and
retry the particular failed payment transaction at the one or more optimal payment retry times.
